(19) United States
(12) Patent Application Publication
(10) Pub. No.: US 2016/0062463 A1
(43) Pub. Date: Mar. 3, 2016

(54) NANOWIRE ENABLED PAPER BASED HAPTIC INTERFACES

(71) Applicant: The Royal Institution for the Advancement of Learning / McGill University, Montreal (CA)

(72) Inventors: XINYU LIU, Verdun (CA); XIAO LI, Montreal (CA); YU-HSUAN WANG, Montreal (CA)

(21) Appl. No.: 14/825,237

(22) Filed: Aug. 13, 2015

Related U.S. Application Data
(60) Provisional application No. 62/036,802, filed on Aug. 13, 2014.

(51) Int. Cl. G06F 3/01; G06F 3/047; G06F 3/0354

(52) U.S. Cl. CPC G06F 3/016; G06F 3/03547; G06F 3/047; G06F 2203/04102

(57) ABSTRACT

Paper, as a ubiquitous material in everyday life, has recently emerged as flexible substrates for electronics. It offers a basis for functional electronic modules with advantages of low cost, ease of fabrication, good printability, high flexibility, and light weight. To date, functional electronic components on paper and paper-like substrates have included diodes, transistors, capacitors, electrochemical biosensors and micro-electro-mechanical systems (MEMS). Accordingly, paper-based flexible sensors and electronics may be applied to a wide range of applications including flexible displays, energy storage, self-folding robotics, and biosensing. These may be further expanded through provisioning of a paper-based human-device interface that allows users to input information. By exploiting piezoelectric nanowires grown upon paper, a range of one- and two-dimensional haptic interfaces may be implemented.

### FIELD OF THE INVENTION

This invention relates to haptic interfaces and more particularly to paper-based haptic interfaces and flexible paper-based haptic interfaces integrable with other paper-based flexible sensors and electronics.

### BACKGROUND OF THE INVENTION

Paper, as a ubiquitous material in everyday life, has recently emerged as flexible substrates for electronics. It offers a basis for functional electronic modules with advantages of low cost, ease of fabrication, good printability, high flexibility, and light weight. To date functional electronic components on paper and paper-like substrates have included diodes, transistors, capacitors, etc. Beyond electronics, other electrically enabled functions have also been realized on paper, as paper-based electrochemical biosensors and paper-based micro-electro-mechanical systems (MEMS). Accordingly, paper-based flexible sensors and electronics (PBFSE) have been utilized for a wide range of applications, flexible displays, energy storage, self-folding robotics, force sensing and electrochemical biosensing.

Accordingly, it is reasonable to predict wider applications of functional paper-based electronic devices in the future. However, one type of integral component required for many paper-based electronic devices is a human-device interface that allows users to input information. It would therefore be beneficial to realize touch-based interfaces directly on paper allowing their integration with other paper based electronics to form integrated circuits that not only include haptic interfaces, but also displays, MEMS, and other electronic functionalities.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to haptic interfaces and more particularly to paper-based haptic interfaces and flexible, paper-based haptic interfaces integrable with other paper-based flexible sensors and electronics.

In accordance with an embodiment of the invention there is provided a haptic interface comprising:
a substrate;
a first layer comprising a paper having a first predetermined region coated with nanowires formed from a material exhibiting piezoelectricity;
a second layer formed from an electrically conductive material patterned with respect to the first predetermined region of the first layer; and
a third layer comprising an insulator disposed atop the first and second layers; wherein
application of pressure to the third layer results in deformation of at least one of the nanowires and a second predetermined region of the first layer thereby generating a first electrical current.

In accordance with an embodiment of the invention there is provided a haptic interface comprising:
a substrate;
a first layer comprising a paper having a first predetermined region coated with nanowires formed from a material exhibiting piezoelectricity;
a second layer formed from an electrically conductive material patterned with respect to the first predetermined region of the first layer; wherein
application of pressure to the first predetermined region of the first layer results in deformation of at least one of the nanowires and a second predetermined region of the first layer thereby generating a first electrical current.

In accordance with an embodiment of the invention there is provided a haptic interface comprising:
a first layer comprising a paper having a first predetermined region coated with nanowires formed from a material exhibiting piezoelectricity;
a second layer formed from an electrically conductive material patterned with respect to the first predetermined region of the first layer; wherein
application of pressure to the first predetermined region of the first layer results in deformation of at least one of the nanowires and a second predetermined region of the first layer thereby generating a first electrical current.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a schematic of the zinc oxide (ZnO) nanowire (ZnO-NW) growth setup together with SEM images of pure cellulose paper and low/high-magnification SEM images of ZnO-NW paper after 15-hour growth;

FIG. 2 depicts TEM images of ZnO NWs grown on paper at low and high magnification together with energy dispersive X-ray spectrum (EDS);

FIG. 3A depicts weight growth percentage of ZnO-NW paper versus concentration of assistant chemical according to embodiments of the invention;

FIG. 3B depicts SEM images of ZnO-NW paper grown under conditions A, D and H according to embodiments of the invention;

FIG. 4 depicts the weight growth percentage of ZnO-NW paper without seeding after 15-hour and 21-hour growth together with SEMS of the non-seeded paper after these growth periods;

FIG. 5 depicts SEM images of ZnO-NW paper under growth conditions according to embodiments of the invention with 5 mM and 2.5 mM PEI after 15-hour growth;

FIG. 6 SEM images and weight growth percentage data of ZnO-NW paper under growth conditions according to an embodiment of the invention after 1.5, 3, 15, and 18-hour growths;

FIG. 7 depicts electrical characterization of ZnO-NW paper after different growth times depicting I-V curves and resistance data after 1.5-hour, 3-hour, and 15-hour growths according to embodiments of the invention with an inset photograph of ZnO-NW paper with silver electrodes;

FIG. 8 depicts resistance of ZnO-NW paper over time upon exposure to UV light and current output from three touch buttons over time upon finger press/release;

FIG. 9A depicts a schematic view of a touch button exploiting ZnO-NWs according to an embodiment of the invention together with typical I-V curves of 4 touch buttons (with ZnO NWs grown for 15 h) with silver-ink electrodes;

FIG. 9B depicts a typical current response of a touch button according to an embodiment of the invention upon repeated finer presses;

FIG. 10 depicts TEM images of a ZnO-nanowire grown according to an embodiment of the invention with an inset electron diffraction image showing lattice orientation along [0001] and EDS spectrum;

FIG. 11A depicts the current responses of pure paper together with ZnO-NW paper and ZnO-NW paper during presses and delayed releases fabricated according to an embodiment of the invention;

FIG. 11B depicts resistance measurements of 3 touch buttons fabricated according to an embodiment of the invention upon pressing with interval and current response of a touch-button made with carbon-coated paper;

FIG. 11C depicts detailed views of current peaks upon pressing and releasing a touch-button according to an embodiment of the invention together with integration curves over time;

FIG. 12 depicts experimental results of average negative current peaks versus growth percentage and force applied for ZnO-NWs grown for 1.5 h, 3 h, and 15 h, yielding 20%, 30%, and 40% weight growth respectively and experimental results of average negative current peaks versus. pressing force;

FIG. 13 depicts experimental results of average negative current peak versus number of presses for a ZnO-NW (n=10 measurements every 200 presses) together with inset of an SEM image of a touch pad after 600 times of presses.

FIG. 14 depicts the voltage outputs from 10 number keys while being dialed together with first LED lighting up when the number key is pressed and second LED lighting up when a pre-programmed password is entered correctly;

FIG. 15 depicts an exploded schematic representation of a paper-based piezoelectric touch pad exploiting ZnO-NWs according to an embodiment of the invention;

FIG. 16 depicts a schematic of a testing cell configuration for paper-based piezoelectric touch pad exploiting ZnO-NWs according to an embodiment of the invention;

FIG. 17 depicts current responses of different touch pad elements within a touch-pad according to an embodiment of the invention.

FIG. 18 depicts an electrical schematic of an example of a readout circuit for a ZnO-NW haptic interface according to an embodiment of the invention; and

FIG. 19 depicts an output voltage response of the readout circuit of FIG. 18 when detecting a finger press.

### DETAILED DESCRIPTION

The present invention is directed to haptic interfaces and more particularly to paper-based haptic interfaces and flexible, paper-based haptic interfaces integrable with other paper-based flexible sensors and electronics.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

Paper, as used herein refers to, but is not limited to, a thin material produced by pressing together moist fibers, typically cellulose pulp derived from wood, natural fibers or grasses, and drying them into flexible sheets.

A “nanostructure” (nanoparticle) as used herein refers to, but is not limited to, a structure having one or more dimensions at the nanometer level, which is typically between the lower and upper dimensions of 0.1 nm and 100 nm. Such structures, may include, nanotubes/nanowires having two dimensions on the nanoscale, and nanoparticles having three dimensions on the nanoscale. Nanotubes may include structures having geometries resembling, but not be limited to, tubes, solid rods, whiskers, and rhomboids with square, rectangular, circular, elliptical, and polygonal cross-sections perpendicular to an axis of the nanotube. Nanoparticles may include structures having geometries representing, but not limited to, spheres, pyramids, and cubes. The cross-sectional geometry of nanotubes and nanoparticles may not be constant such that a nanostructure may taper in one or two dimensions.

A “nanowire” as used herein refers to, but is not limited to, a structure within the category of nanotubes by virtue of being nanoscale on two dimensions and solid cross-sectionally formed from one or more materials.

A “metal” as used herein refers to, but is not limited to, a material (an element, compound, or alloy) that has good electrical and thermal conductivity as a result of readily losing outer shell electrons which generally provides a free flowing electron cloud. This may include, but not be limited to, gold, chromium, aluminum, silver, platinum, nickel, copper, rhodium, palladium, tungsten, palladium, and combinations of such materials

An “electrode”, “contact”, “track”, “trace”, or “electrical terminal” as used herein refers to, but is not limited to, a material having an electrical conductivity which is optically opaque. This includes structures formed from thin films, thick films, and plated films for example of materials including, but not limited to, metals such as gold, chromium, aluminum, silver, platinum, nickel, copper, rhodium, palladium, tungsten, palladium, and combinations of such materials. Other electrode configurations may employ, for example, a chromium adhesion layer and a gold electrode layer or other combinations of metals such as adhesion layer, body of electrode and passivation/protection layer.

A. Zinc Oxide Nanowire Growth

A.1 Background

Within the prior art, functional nanomaterials, such as carbon nanotubes (CNTs) and graphene, have been introduced to paper-based flexible sensors and electronics (PBFSEs) to enrich their capability. The integration of CNTs into paper leads to high conductivity of the paper substrate, with which paper-based batteries have been developed. The enhanced conductivity along with the high surface-to-volume ratio achieved by CNTs on paper also guaranteed improved performance of paper-based electrochemical biosensors. Graphene has been reported for similar purposes in electrochemical biosensing. However, the syntheses of CNTs and graphene require special equipment and processes that are often sophisticated and expensive. Further, the post-hoc integration of these nanomaterials on paper with satisfactory uniform coverage could be troublesome and require protocol optimization. In order to better fulfill the promise of PBFSEs, other functional nanomaterials that are easy to synthesize and integrate on paper are highly desirable.

Zinc oxide nanowires (ZnO-NWs) are particularly promising for PBFSEs for two major reasons. First, it is a multifunctional nanomaterial for electronics and sensing. ZnO-NWs are semiconductors, piezoelectric, photoluminescent, ultra-violet (UV) light responsive, etc. These properties can be potentially well-employed in PBFSE, and serve to such ends as piezoelectric sensing and energy harvesting. Secondly, high-quality ZnO-NWs can be grown from an aqueous phase through a hydrothermal process as described and presented below in respect of embodiments of the invention for convenient low complexity processing of paper as the substrate. This process not only retains porosity and flexibility of paper, but can also be performed at a very low cost.

A.2 Hydrothermal Growth of Zinc Oxide Nanowires on Paper

The hydrothermal growth of ZnO-NWs on a paper substrate includes two steps:
(i) uniform coating on the substrate with a seeding layer of ZnO nanoparticles (NPs) which provides the starting points of the ZnO-NW growth; and
(ii) directional nucleation of ZnO-NWs from the seeding layer.

In the first step, the inventors prepared the ZnO NPs in ethanol via the following procedures. 40 mL of 2 mM zinc acetate dihydrate (ZAD) and 20 mL of 4 mM sodium hydroxide (SH) solutions were prepared respectively in pure ethanol by heating and stirring on a hotplate. After both solutions were cooled down to room temperature, the SH solution was slowly poured into the ZAD solution along the wall of the beaker, with constant stirring. The mixed solution was heated for 2 h at 60° C., to form a colloidal solution of ZnO NPs. Four 30 mm×30 mm square pieces of Whatman® 3 MM paper (340 μm thick) were then dipped into the solution for 3 minutes before being taken out and dried at 100° C. for another 3 minutes. The dipping and drying step was repeated 6 times, and the side of the paper piece facing down was alternated in each drying step, in order to cancel out the effect that gravity drags more ZnO-NP solution to the downside. Through this process, ZnO NPs were uniformly coated on the surface of cellulose fibers as a quasi-film.

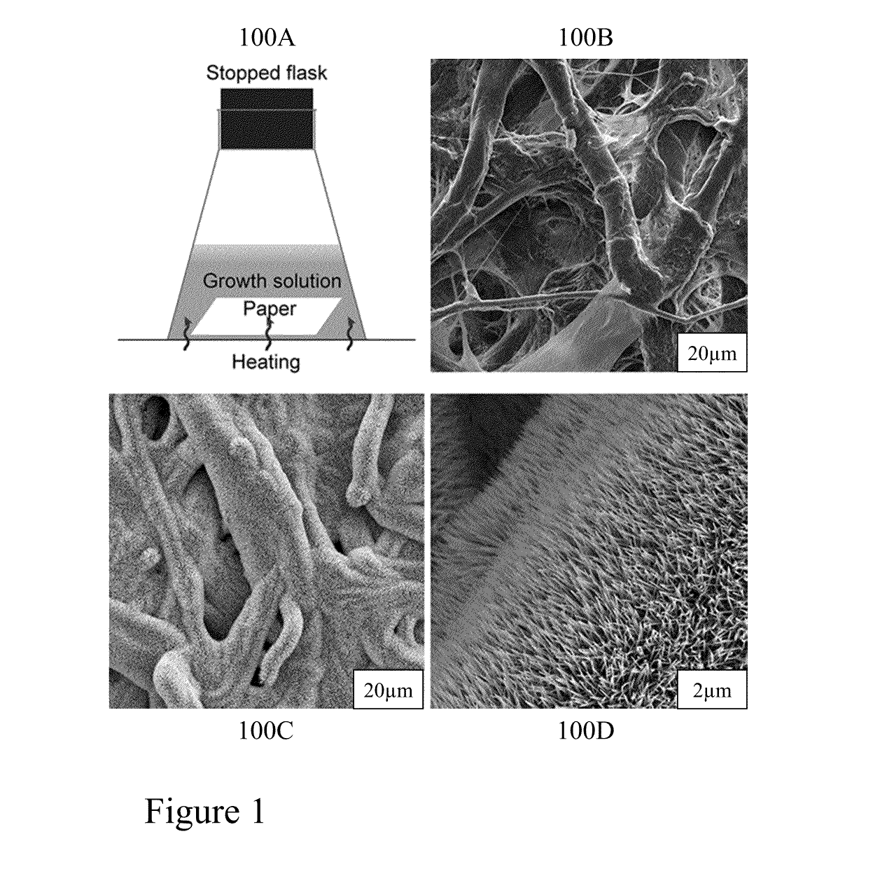

In the second step of the hydrothermal growth, the ZnO-NP-coated paper is immersed in an aqueous solution of zinc salt and other chemicals at an elevated temperature for the growth of ZnO-NWs. Schematic 100A in FIG. 1 illustrates the experimental setup, which simply consists of a stopped flask sitting in a convection oven. The inventors used zinc nitrate hexahydrate (ZNH) as the salt to provide zinc composition in ZnO-NWs, and hexamethyl-enetetramine (HMTA) as a typical mediator in growth. 50 mM ZNH and 25 mM HMTA formed the growth solution, based on which the other factors were further tuned. A major challenge in this growth process is the competition between the homogeneous nucleation in the solution and the heterogeneous nucleation on paper. The inventors tested four specific factors to favor the heterogeneous nucleation and thus to obtain higher yield of ZnO-NWs with improved morphology.

The first factor the inventors tested is the heating temperature at which the growth was performed wherein the ZnO-NW growth in growth solution heated at a temperature ranging 30-70° C. (in 10° C. increments). This range is lower than the normal range of temperature used for ZnO-NW growth (80-100° C.), as the inventors surmised that this inhibits homogeneous nucleation and favors heterogeneous nucleation. The second parameter is the addition of ammonium hydroxide (AH) to the growth solution, as AH has been shown to improve ZnO-NW growth on glass substrates. In the experiments presented here, AH was added into the growth solution at a concentration changing from 0.074 M to 0.595 M (see Table 1).

TABLE 1
Concentration of AH in the Growth Solution (50 MM ZAD, 25 MM
HMTA)

| Condition | AH Concentration (M) |
|---|---|
| A | 0.000 |
| B | 0.074 |
| C | 0.149 |
| D | 0.223 |
| E | 0.298 |
| F | 0.372 |
| G | 0.446 |
| H | 0.521 |
| I | 0.595 |

The third factor was the seeding layer which is commonly known to offer starting points for high-quality hydrothermal ZnO-NW growth, whereas some prior art work has demonstrated high-yield ZnO-NW growth from seedless substrates. The goal of the inventors' experiments was to explore the possibility of growing ZnO-NWs on seedless cellular paper, which, if successful, could simplify the hydrothermal growth process. The inventors compared ZnO-NW growth on paper samples with and without a seeding layer, in the growth solution with AH at the concentration that yields the highest growth. The fourth factor is the use of polyethylenimine (PEI; branched and at low molecular weight), an assistant chemical reported in the prior art to obtain thin and long ZnO-NWs. For all the conditions, after a predetermined growth time, the paper pieces were taken out, thoroughly washed with deionized (DI) water, dried at 86° C., ultrasonicated in pure ethanol for 2 min, and finally dried again at 86° C. In order to quantify the yield of ZnO-NW growth on cellulose fibers, the inventors used weight growth percentage as an indicator, which is defined as the relative weight increase (in percentage) of a paper piece after growth as given by Equation (1). When tuning the all the four factors, the inventors used the same growth solution of 50 mM ZND and 25 mM HMTA.

$${Weight}_{GROWTH} ( \% ) = \frac{{Weight}_{AFTERGROWTH \_} - {Weight}_{BEFOREGROWTH}}{{Weight}_{BEFOREGROWTH}} \qquad ( 1 )$$

A.3 Fabrication and Testing of ZnO-NW Paper Sensors

The inventors explored the feasibility of using ZnO-NW paper as a sensing component in PBFSE. As electrical contact is needed in all electrical sensing applications, the inventors used a brush to manually draw silver ink on two edges of a 30 mm×30 mm piece of ZnO-NW paper, which formed electrodes (5 mm wide) after drying. The current-voltage (I-V) curve of the ZnO-NW paper piece was then measured by a precision Potentiostat.

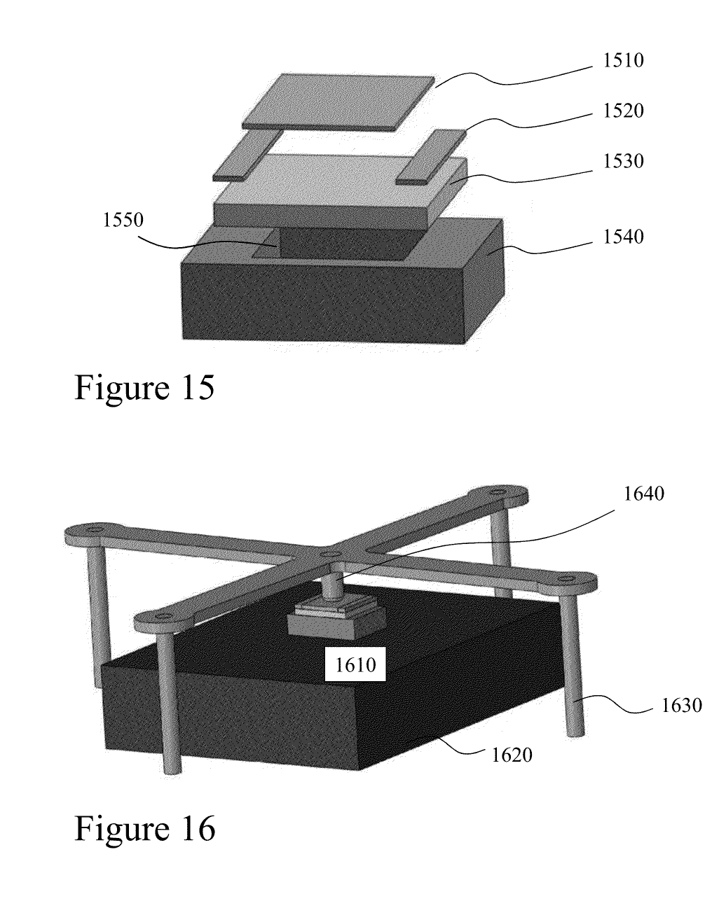

In UV sensing experiments, the inventors placed the ZnO-NW paper under uniform UV illumination (λ=365 nm, 24 mWcm⁻²), and measured the resistance value of the ZnO-NW paper using a multimeter at 0.2 Hz. UV illumination frees electrons in ZnO-NWs, so that the conductivity of ZnO-NWs is expected to increase. In the touch sensing experiment, the inventors used ZnO-NW paper of the same dimensions with silver electrodes. The inventors used a laser cutter to cut a 30 mm×30 mm piece of board paper (3.8 mm thick) with a hollow square of 20 mm×20 mm in the center. The ZnO-NW paper was attached to the board paper using double-sided adhesive tape to form a touch button (see FIG. 15). When the suspended ZnO-NW paper is deformed, ZnO-NWs bend and rub against each other and piezoelectric charges are subsequently generated. A precision potentiostat was used to quantify the piezoelectric current generated from the paper button upon pressing by a gloved finger.

A.4 Results and Discussions

A.4.1. Growth of ZnO-NWs

The inventors measured and observed ZnO-NWs grown on paper under the various conditions by tuning the four factors (temperature, AH, seeding layer, and PEI), as mentioned supra. The inventors found that the ZnO-NWs were successfully grown on ZnO-NP-seeded paper with the highest yield under Condition F (0.372 M AH in the growth solution) in Table 1, while the other conditions generated lower yield or did not produce desirable ZnO-NW morphology on paper due to the reasons the inventors will discuss in subsequent section A.4.2.

SEM imaging of pure paper shows the network of bare and non-smooth cellulose fibers, see for example first SEM image 100B in FIG. 1. After hydrothermal growth under Condition F for 15 h, ZnO-NWs fully covered the surfaces of cellulose fibers (second SEM image 100C in FIG. 1) with radial alignment outwards from the fibers (high-magnification SEM image in third SEM image 100D in FIG. 1).

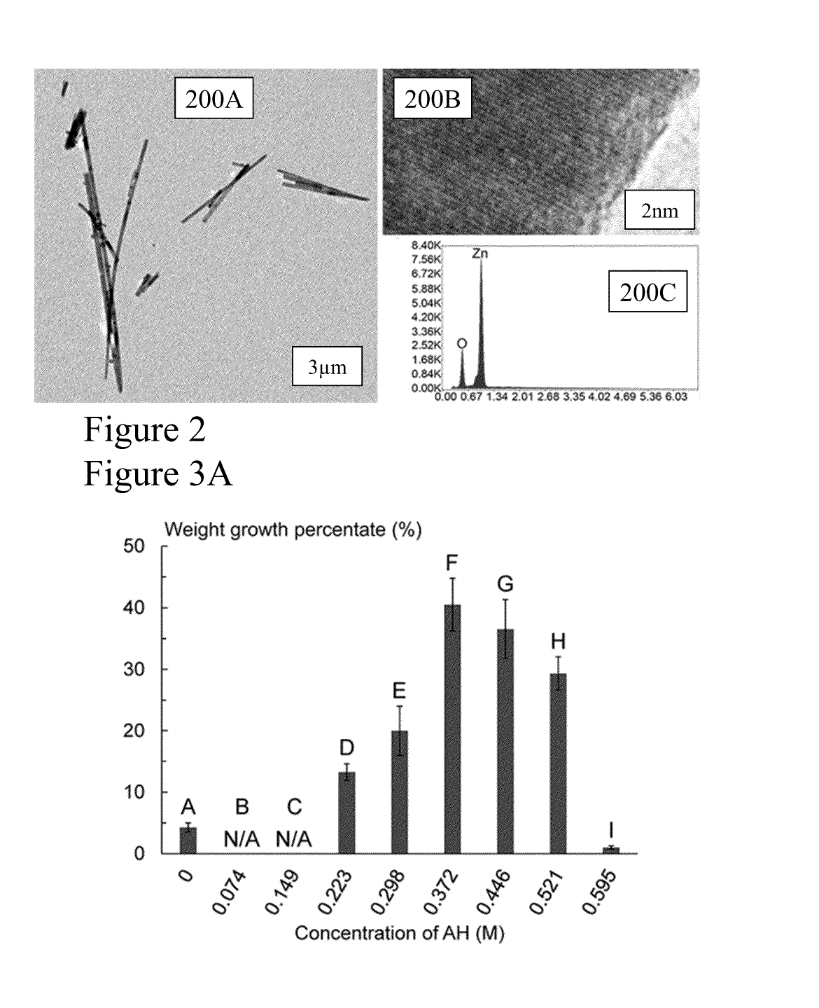

The inventors characterized the crystal quality of obtained ZnO-NWs using transmission electron microscopy (TEM) and energy dispersive spectroscopy (EDS). TEM imaging at low magnification shows uniform width along the length of the ZnO-NWs (first TEM image 200A in FIG. 2). The width of the ZnO-NWs is well-located at the nanometer scale (63.74±9.93 nm, n=10). TEM imaging at high magnification on a single ZnO shows clear lattice structure and a lattice spacing of 0.264 nm was measured among the (0002) crystal planes (second TEM image 200B in FIG. 2). The EDS spectrum shows clear peaks of zinc (Zn) and oxygen (O) (graph 200C in FIG. 2). EDS analyses on 20 points of different ZnO-NWs revealed that the ratios of zinc and oxygen atoms were 47.31±1.87% and 52.69±1.87%, respectively. The results indicate correct chemical composition of the obtained ZnO-NWs.

A.4.2 Tuning the Conditions of ZnO-NW Growth

During hydrothermal growth of ZnO-NWs, there exists the competition between homogeneous nucleation (in solution) and heterogeneous nucleation (on the surface of cellulose fibers) of ZnO, and the inventors' goal was essentially to favor the heterogeneous nucleation and thus promote the ZnO-NW growth on paper surface. One possible solution is to lower the temperature, because generally heterogeneous nucleation has the lower energy barrier. As a result, a lower temperature may inhibit homogeneous nucleation and favor heterogeneous nucleation. Given that the commonly used temperature range for hydrothermal ZnO-NW growth is within 80-100° C., the inventors tested a series of temperature values with the growth solution (just ZNH and HMTA, without other assistant chemicals) at a lower range of 30-70° C. The inventors found that there were always white aggregates formed in the growth solution after 15 hours heating at all the temperature values the inventors tried, and that the amount of the white aggregates increased with temperature. These white aggregates were ZnO wires grown in solution through homogeneous nucleation. On the other hand, the heterogeneous nucleation was almost fully suppressed, as the weight growth percentage from all the samples were almost zero after 15-hour growth (data not presented here). Thus, the inventors concluded that, under their experimental conditions, lower temperature cannot effectively favor heterogeneous nucleation over homogeneous nucleation.

The inventors then tested the effect of an assistant chemical (AH) on ZnO-NW growth. AH in growth solution forms complexes of Zn(NH₃)ₙ²⁺ as buffers to supply Zn²⁺. The super-saturation degree of Zn2+ in solution is thus lowered, suppressing homogeneous nucleation [23]. The inventors selected a typical growth temperature of 86° C., tested a range of AH concentrations (Table 1) and examined the growth results in three ways: observing the growth solution; measuring the weight growth percentage; and observing the morphology of ZnO-NWs in SEM.

The inventors observed that, after adding AH to growth solutions at different concentrations (Table 1), most of the growth solutions became clear after shaking except for Conditions B (0.074 M AH) and C (0.149 M AH), as these two conditions formed white aggregates that stayed in the solutions. This was because AH first reacted with zinc ions in the solution to form Zn(OH)₂, which is slightly soluble in water at neutral pH and becomes more soluble at higher pH values. With more AH added, the growth solution became more basic and more Zn(OH)₂ was dissolved. The white aggregates in the growth solutions with 0.074 M and 0.149 M AH were the Zn(OH)₂ which could not be fully dissolved due to a low concentration of AH. These two conditions may not provide sufficient zinc ions to support the growth the ZnO-NWs; thus the inventors did not conduct the growth experiments with them.

Observation of other growth solutions with different AH concentrations revealed the effect of AH on nucleation process, after being heated at 86° C. for 15 h. Without AH (Condition A) there were many white aggregates formed in the solution, indicating abundant undesired homogeneous nucleation. At low AH concentrations (Conditions D and E), the white aggregates were fewer, which implies more suppressed homogeneous nucleation. Also, there was a thick white coating on the bottom of flask, which probably was a result of heterogeneous nucleation. Under Conditions F and G, there was almost no white aggregate and the white coating on the flask bottom was light. With even more AH under conditions H and I, both of the white aggregates and white coating disappeared, which indicates that both nucleation types were suppressed.

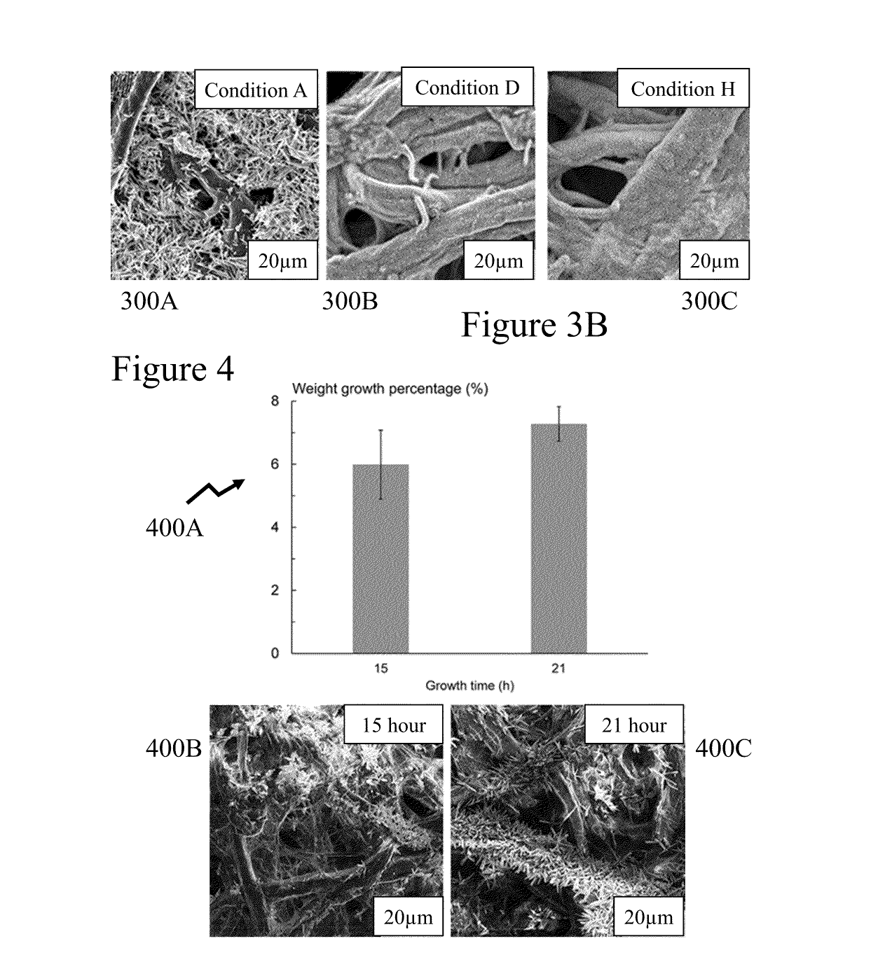

The measurement results of the weight growth percentage of ZnO-NWs on paper pieces under different conditions (Table 1) are presented in FIG. 3A. Comparison among Conditions A, D, E, and F implies that AH did improve the heterogeneous nucleation and suppress homogeneous nucleation, and the growth percentage increased with more AH added (except for Conditions B and C, for the reason the inventors explained previously). With 0.372 M of AH (Condition F), the growth percentage reached the peak value, and further increase of AH concentration led to decrease of the growth percentage. Because the inventors observed the limited growth rate on paper (heterogeneous nucleation) and clear solution after growth (homogeneous nucleation) when AH concentration was higher than 0.372 M, most likely both heterogeneous and homogeneous nucleation processes were suppressed. With the AH at high concentration, there were consequently abundant Zn(NH₃)ₙ²⁺ complexes that captures almost all the Zn²⁺ ions, so that all the nucleation processes were significantly slowed down and no apparent ZnO-NW growth was observed over the given growth time.

As revealed by SEM imaging, there was almost no ZnO-NWs grown from cellulose fibers under Condition A (first SEM 300A in FIG. 3B), whereas micrometer-sized ZnO wires (ZnO microwires) were synthesized in solution (through homogeneous nucleation) and finally attached to (vs. rooted on, through heterogeneous nucleation) the cellulose fibers. The inventors found that these ZnO microwires could be removed by ultrasonication in ethanol. As for all the conditions that generate considerable growth weight percentage (Conditions D, E, F, G, and H), the inventors observed ZnO-NWs grew from, and covered, the cellulose fibers (second and third SEMs 300C and 300D in FIG. 3B). The difference between these conditions is reflected in the weight growth percentage which might be due to the length and density of ZnO-NWs, as well as the accumulation of the ZnO films which evolved from the ZnO-NP seeding layers.

All these results on growth solution condition, growth rate, and ZnO morphology show good consistency, and indicate that, under our experimental conditions, the AH concentration of 0.372 M generates the maximum weight growth percentage. Therefore the inventors used Condition F as the basic condition to further study the other two factors.

One factor is seeding layer, which is known to provide starting points for ZnO-NW growth and to ensure good crystal quality. The inventors found out that, under Condition F, paper without seeding gained little weight growth percentage after 15 hours or 21 hours growth (graph 400A in FIG. 4). In the growth solution, there was almost no white aggregate, because the homogenous nucleation was suppressed by AH; in contrast, a thick white coating was formed on the flask bottom, because bare cellulose paper cannot compete with the flask bottom for the heterogeneous nucleation. SEM imaging shows that the surfaces of cellulose fibers are generally not covered by ZnO-NWs after growth, and ZnO microwires were formed from some spots (SEMs 400B and 400C in FIG. 4). This observation could be explained by the speculation that, over a long period of heating in the environment with zinc ion, low-quality ZnO NPs were generated on certain areas and initiated the growth of these ZnO microwires.

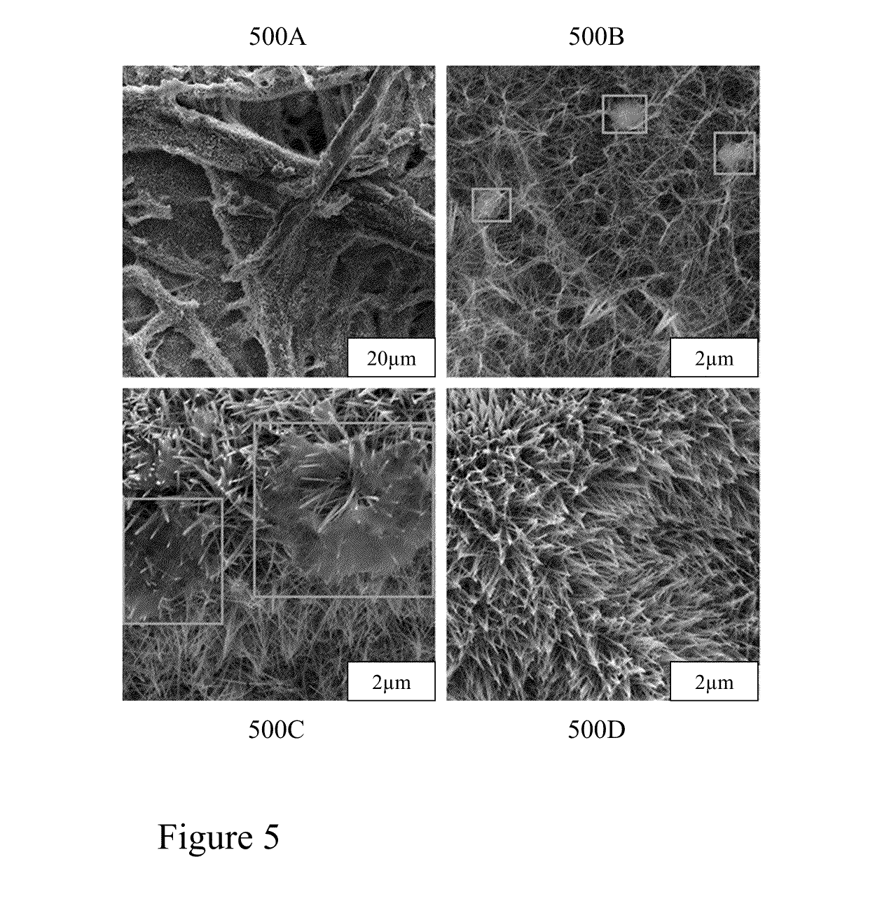

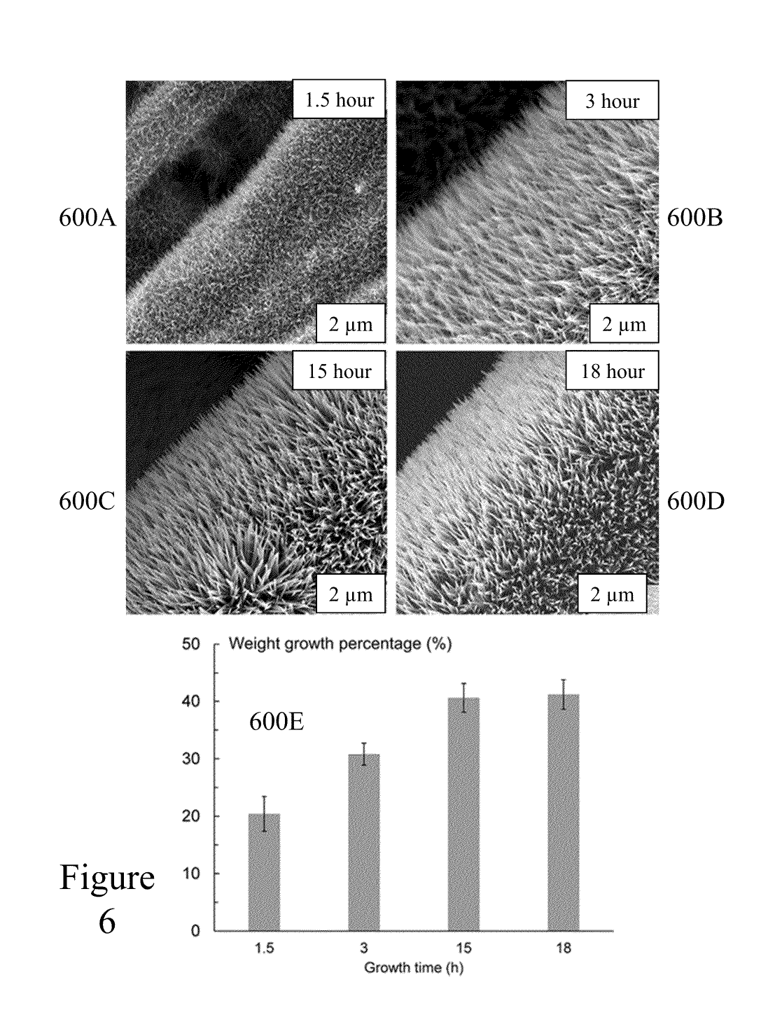

The last factor the inventors investigated is the addition of PEI in the growth solution, which has been used to reduce the width of ZnO-NWs synthesized on silicon wafers, because it can attach to the non-polar surfaces of ZnO-NW crystals and thus confine the lateral growth. The inventors first tried 5 mM PEI in the growth solution, which is a concentration used in another report. However, PEI at this concentration interfered with the growth of ZnO-NWs on paper. SEM imaging at low magnification shows many aggregates on cellulose fibers (first SEM image 500A in FIG. 5), and closer observations revealed that the aggregates are fused ZnO-NWs because of orientation (second SEM image 500B in FIG. 5). On some spots, thick PEI polymer layer even covered ZnO-NWs (third SEM image 500C in FIG. 5). Therefore, the inventors reduced the PEI concentration to 2.5 mM in a subsequent attempt, and found that the obtained ZnO-NWs have regular morphology without fusing and no PEI coverage was formed on ZnO-NWs (fourth SEM image 500D in FIG. 5). The average widths of ZnO-NWs were 60.07±10.03 nm (n=10) with 5 mM PEI and 67.01±19.82 nm (n=10) with 2.5 mM PEI, both of which are not significantly different from that of ZnO-NWs grown without PEI (63.74±9.93 nm). The inventors did not try even lower concentrations of PEI as this is unlikely to reduce the width of the ZnO-NWs under these conditions. Based on these results, the inventors concluded that PEI, under the tested growth condition, does not significantly reduce the width of the synthesized ZnO-NWs on paper. Through the investigation on the parameters of ZnO-NW growth, the inventors eventually selected Condition F (Table 1) with ZnO-NP-seeded paper pieces as the standard growth condition in the following studies. One should note that it is possible to further tune the growth parameters to generate even higher yield of ZnO-NW growth. For that purpose, extensive optimization experiments are required.

A.4.3 Controlling the Growth Rate of ZnO-NWs

The ability to control the growth level of ZnO-NWs will significantly benefit their applications in PBFSE, because the properties of ZnO-NW-based electronic components on paper are often associated with the growth level of ZnO-NWs. In the previous section, the inventors investigated the effects of several growth parameters on the yield of ZnO-NW synthesis. Here, the inventors demonstrate the controllability of ZnO-NW growth percentage by fixing the growth condition that yields the optimal growth (Condition F in Table 1) and adjusting the growth time. It is a common observation that the length of ZnO-NWs increases over time in the hydrothermal process. The SEM images of ZnO-NWs the inventors obtained after different growth times (1.5 hours, 3 hours, 15 hours and 18 hours) followed a similar trend, as shown in first to fourth SEM images 600A to 600D in FIG. 6. After 1.5-hour growth, there are only short extrusions from the surfaces of cellulose fibers (first SEM image 600A in FIG. 6), in apparent contrast to the ZnO-NW morphology after longer growth periods (second to fourth SEM images 600B to 600D in FIG. 6). Note that the surfaces of cellulose fibers are not flat, making it difficult to identify the roots of ZnO-NWs in the SEM images (first to fourth SEM images 600A to 600D in FIG. 6) and measure their length precisely. Therefore, we used the weight growth percentage to quantify the amount of synthesized ZnO-NW. As shown in graph 600E in FIG. 6, the weight growth percentage increased considerably with the growth time in the range of 0-15 hours, but slowed down after 15-hour growth. There was little increase of the weight growth rate from 15-hour growth to 18-hour growth, probably because of the depletion of chemicals in the growth solution. Accordingly, a continuous replenishment and/or circulation of solution around the paper would reduce/eliminate this, allowing longer nanowires to be grown.

The inventors also measured the width of ZnO-NWs over growth time, and there was no significant difference among all the tested growth periods. Thus, the increase of weight growth percentage is most likely a result of the length increase, as well as the accumulation of a ZnO layer at the roots of ZnO-NWs (evolved from the ZnO-NP seeding layer).

A.4.4 Electrical Characterization of ZnO-NW Paper

Given the apparent increases of the weight growth percentage of ZnO-NWs after growth for 1.5 hours, 3 hours, and 15 hours, it is possible to observe corresponding changes in the electrical property (e.g., resistance) of ZnO-NW paper pieces associated with growth time. The inventors performed current-voltage (I-V) characterization on 30 mm×30 mm paper pieces grown for 1.5 hours, 3 hours, and 15 hours.

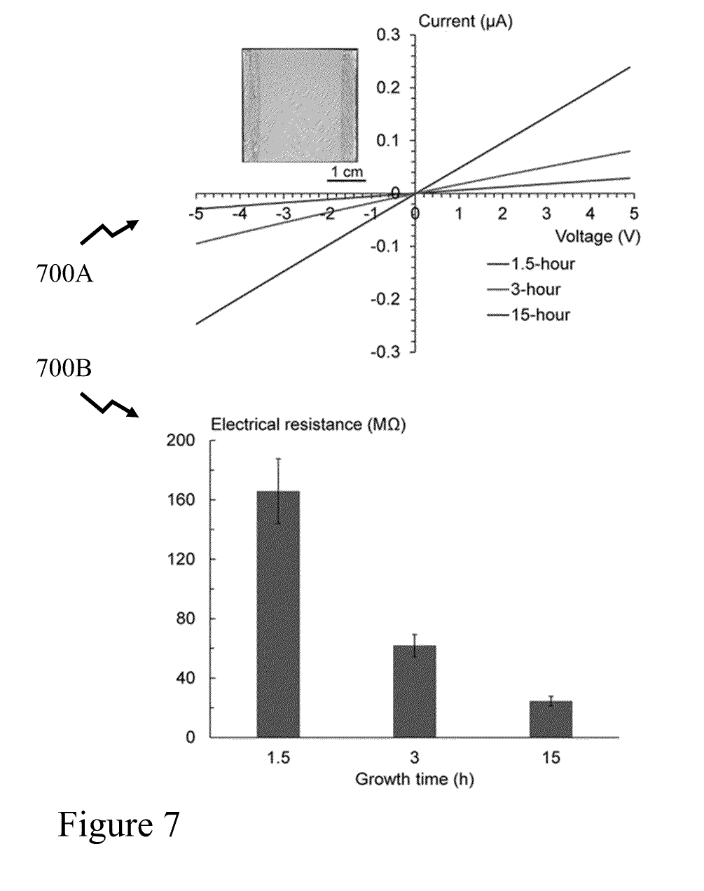

After patterning silver electrodes on the ZnO-NW paper pieces, the inventors measured their I-V characteristics with a precision potentiostat. First graph 700A in FIG. 7 depicts typical I-V curves of ZnO-NW paper pieces after growth for 1.5 hours, 3 hours, and 15 hours. All the I-V curves are linear, demonstrating Ohmic contacts between the silver electrodes and the ZnO-NWs. In terms of electrical resistance, the ZnO-NW paper after longer growth time is more conductive (second graph 700B in FIG. 7). This trend could be attributed to two possible reasons: (i) longer growth time yields a thicker root layer of the ZnO-NWs, and thus decreases the resistance of the ZnO-NW paper; and (ii) longer ZnO-NWs have more contacts with each other, providing more avenues for electron transfer. With these results, the inventors established the approach to adjusting the electrical resistance of ZnO-NW paper on the demand of specific PBFSE designs, by correlating the growth time, weight growth percentage, and electrical resistance. Although the inventors did not test other properties (e.g. piezoresistivity) of ZnO-NW paper pieces over growth time, it is reasonable to predict some of these properties could be adjusted with growth time and growth percentage.

A.5 Demonstration of Touch and UV Sensing

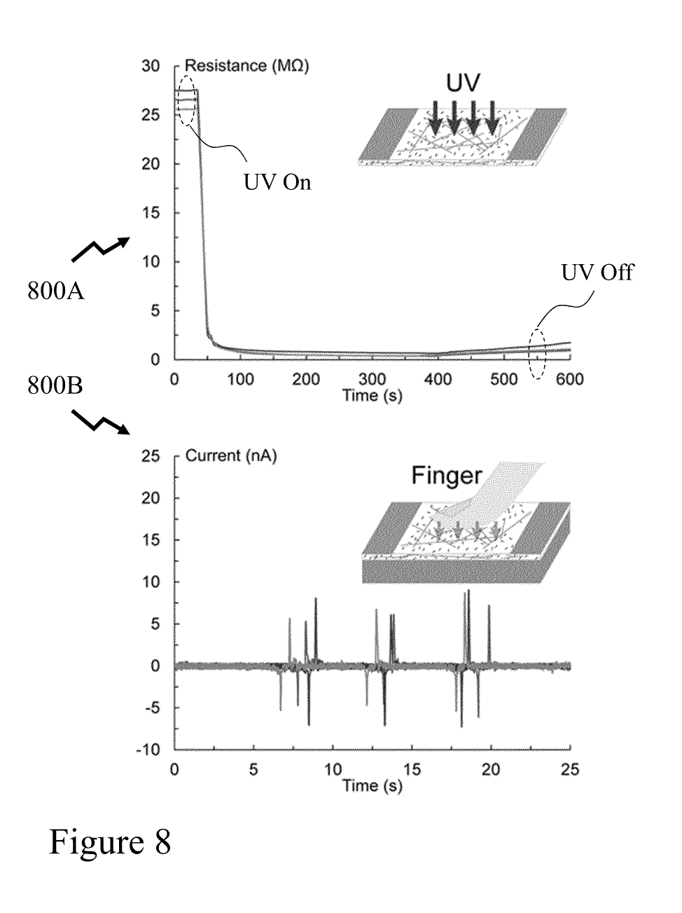

As mentioned previously, ZnO-NWs have multiple sensing functionalities, which are potentially useful in many PBFSE applications. The inventors demonstrated two interesting applications of ZnO-NW paper: touch and UV light sensing. The UV light detection can be performed using a single piece of ZnO-NW paper, while the touch sensing prefers the paper piece to be suspended to gain higher piezoelectric current output. Thus, for the touch sensing demonstration, the inventors made a paper button with ZnO-NW paper and regular board paper (inset of second graph 800B in FIG. 8), which is easy to dispose and environmentally-friendly.

When ZnO-NWs are exposed in air, oxygen molecules are absorbed to their surfaces, and capture free electrons on the ZnO-NW surface. Upon exposure to UV light, there are electron-hole pairs generated in the ZnO-NWs, and oxygen molecules leave by taking the holes. Consequently, more electrons in ZnO-NWs are freed, and the resistivity of ZnO-NWs decreases. According to the experimental results shown in first graph 800A in FIG. 8, the resistance of ZnO-NW paper decreased by approximately 90% (from about 25-28MΩ to about 2.6-3.8MΩ) after 5 seconds of UV light exposure. With continuous exposure to UV for over 350 seconds, the resistance of the ZnO-NW paper slowly decreased down to 0.4-0.7MΩ. When the UV light was turned off, the resistance of the ZnO-NW paper slowly returned to its original value.

ZnO-NWs are also well-known for piezoelectricity. When they are deformed, the electrical centers are displaced, which generates a piezoelectric potential on ZnO-NWs, or a piezoelectric charge flow (current) when a circuit loop is formed with the ZnO-NW paper. As shown in second graph 800B in FIG. 8B, a finger press-release process on the paper button induced a pair of negative and positive current peaks at the nano-ampere level. When the ZnO-NW paper was pressed, the ZnO-NWs rubbed and bent against each other, which generated an overall piezoelectric potential between the two electrodes. A charge flow compensated this potential and dissipated quickly through the measurement loop, and a negative current peak was detected. When the finger was released, the reposition of the electrical centers of ZnO-NWs generated a backward charge flows in the circuit, seen as a positive current peak.

The responses of ZnO-NW paper to the two different external inputs (UV light and touch force) are useful to PBFSE. For example, synthesized ZnO-NW paper can be used as a multifunctional sensing component, allowing PBFSE devices to detect environmental inputs. They can also be used as triggering/controlling mechanisms for PBFSE systems. For instance, a UV input can adjust the resistance of the ZnO-NW paper and thus regulate the current through a paper-based electronic circuit, and a finger press by a user can generate an electrical signal to activate/deactivate a paper-based circuit.

B. Paper Touch Sensor/Keypad

B.1 Fabrication of the Paper-Based Touch Buttons.

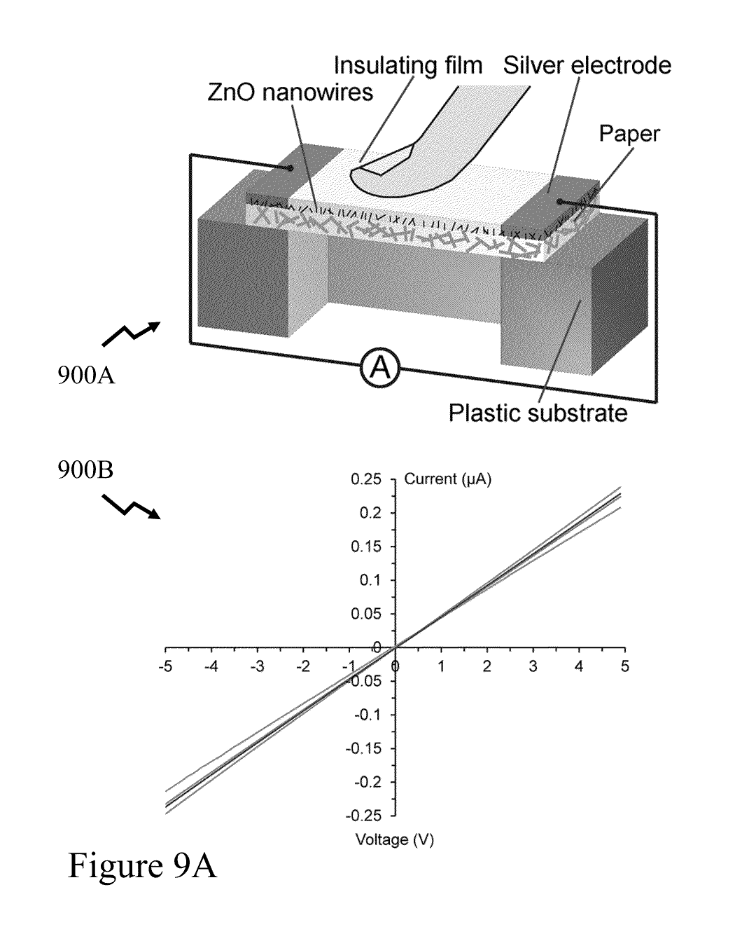

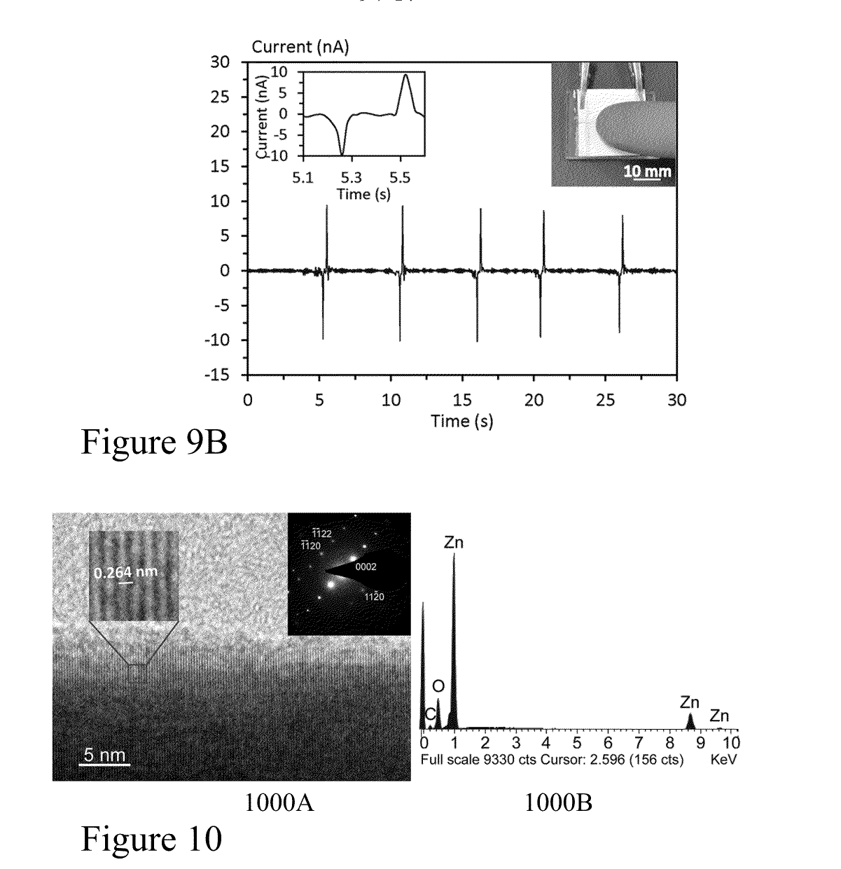

A three-dimensional (3D) cross-section view of a touch button is illustrated in schematic 900A in FIG. 9A. The inventors selected Whatman® 3 MM chromatography paper, which is widely used for fabricating microfluidic devices, for initial experimental demonstrations, to fabricate the touch buttons, because: (i) its composition of pure cellulose makes the hydrothermal growth of ZnO-NWs more reproducible; and (ii) its relatively thick structure (340 μm) is mechanically stable and can hence better withstand pressing-induced deformations. However, the concepts, methodologies, processes etc. described herein within the specification may be applied to other papers and fabrics although growth conditions may require adjustment in these instances. Accordingly, ZnO-NWs can also be readily grown on other common paper substrates such as packing paper and plain printing paper, and the inventors touch button design, in principle, can be realized on many other types of paper as long as the paper substrate provides adequate mechanical strength for finger pressing. Similarly, fabrics may be patterned with nanowires and touch sensitive buttons formed, thereby allowing a fabric-forming part of a wearable device to now include a haptic interface.

After the growth of ZnO-NWs, the paper pieces were screen printed with silver ink on their top surfaces to form electrodes (3 mm×26 mm) and dried at 80° C. for 1 hour. The silver electrodes form Ohmic contacts with the ZnO-NW paper (graph 900B in FIG. 9A). A layer of insulating adhesive film was then disposed atop the surface of the paper, and finally attached the paper to an acrylic piece (3 mm thick) with a central square cavity (20 mm×20 mm) using double-sided tape. The insulating adhesive film employed was Scotch® single-sided transparent moving and storage tape which is made from polypropylene film backing and acrylic adhesive. The thickness of the backing is 0.040 mm, and the nominal thickness of the tape is 0.063 mm, with a sheet resistance for the polypropylene film backing at the level of 10¹² Ω/sq., and the sheet resistance of the acrylic adhesive is at the level of 10⁹ Ω/sq. such that the overall resistance of the tape used in each touch button can be estimated to be at the level of 10¹² Ω/sq.

FIG. 9B depicts the typical current response of a touch button upon repeated finger presses, measured by a precision potentiostat at a sample rate of 50 Hz. A negative current peak at the nano-ampere level appeared while pressing and then quickly dissipated through the closed circuit loop. Upon finger release, the deformed paper restored and generated a positive current peak. The inventors attribute the piezoelectric current output to two types of deformations of ZnO-NWs on paper: (i) the deformations of ZnO-NWs in the touch area of the paper that were induced directly by a finger press; and (ii) the deformations of ZnO-NWs in the non-touched area of the paper that were induced by the deformations of the paper fibers they rooted on (which caused the ZnO-NWs on them to contact each other and thus get bent). Thus, the presence of a cavity under the touch pad allows the paper fibers in the non-touched area to deform and thus produce piezoelectric currents from the ZnO-NWs on them. It is also possible to have a design with a ZnO-NW paper button sitting on a solid substrate, although it is anticipated that, absent the second effect, a lower level of current output will be generated.

To make the applied force and resulted deformation more consistent, in the following experiments to characterize the individual touch buttons the inventors used a machine-shop-made metal stand with a finger-shaped tip to mimic finger pressing. By changing the deformation depth, the inventors were able to control the force applied to the touch button, per FIG. 16 and the description below. The tip of the metal stand that exerted a touch force to the touch button has a flat circular area of 0.785 cm² (1 cm in diameter), similar to the size of a finger press. The inventors applied consistent pressing force of 17.6±1.2N with the metal stand in experiments and the inventors released the tip right after pressing, unless otherwise specified.

B.2 Quality of ZnO-NWs Grown on Paper.

The inventors synthesized the ZnO NPs using the processes described above and formed the initial seeding layer on the paper through a simple dipping process. Because there are abundant —OH groups on the surface of cellulose fibers of paper, these —OH groups can form hydrogen bonds with the surface oxygen atoms of ZnO nanoparticles. The multiple dipping steps helped rearrange the ZnO NPs attached to cellulose fibers to form more uniform layers. Atomic layer deposition could be also used to generate high-quality, texture-controlled seeding layer of ZnO as an alternate process step. The controlled texture and crystal orientation of the seeding layer could affect the orientation and quality of subsequently grown ZnO-NWs.

After 15-hours growth, the ZnO-NWs had an average length of 2.48±0.17 μm, an average width of 69.61±9.55 nm and average density of 30.30±5.40/μm² (n=20 from five paper samples). Clear crystal lattice structures of ZnO-NWs were observed via high-resolution TEM imaging (TEM image 1000A in FIG. 10), which shows a 0.264 nm lattice spacing for the (0002) crystal planes. The electron diffraction image of a selected area inset TEM image 1000A indicated the lattice orientation along [0001], which is the c-axis of ZnO crystalline. Clear peaks of Zn and O in the spectrum obtained from EDS indicate correct molecular composition of the NWs (graph 1000B in FIG. 10).

B.3 Investigation of Piezoelectric Response of Touch Pads.

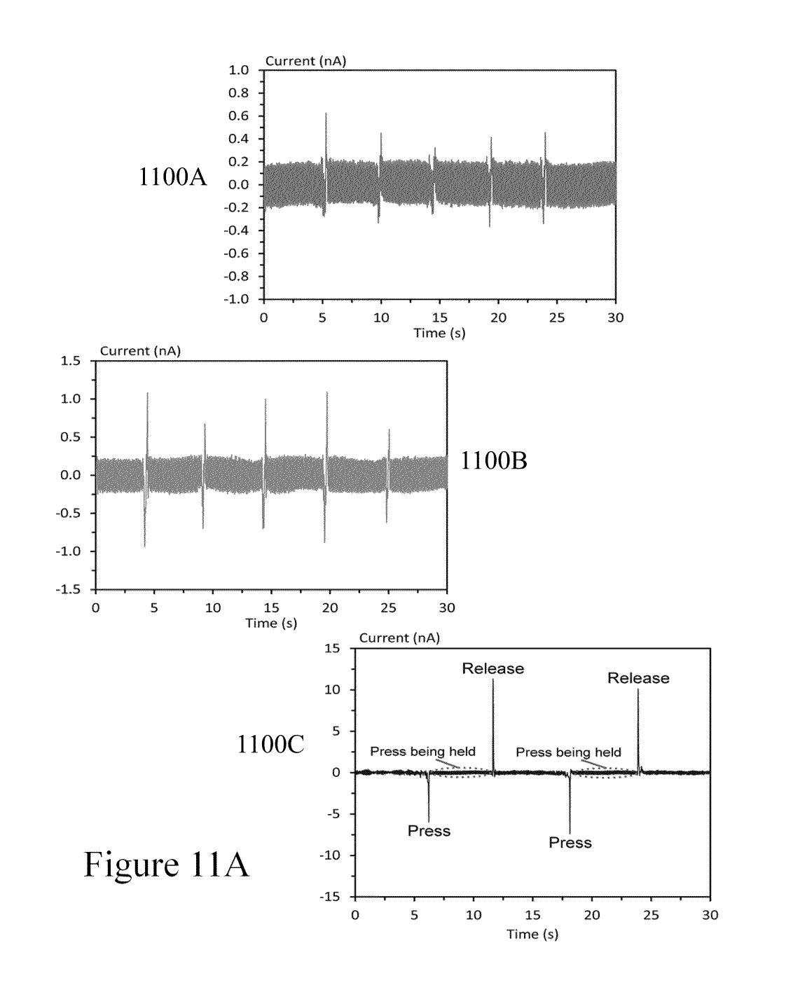

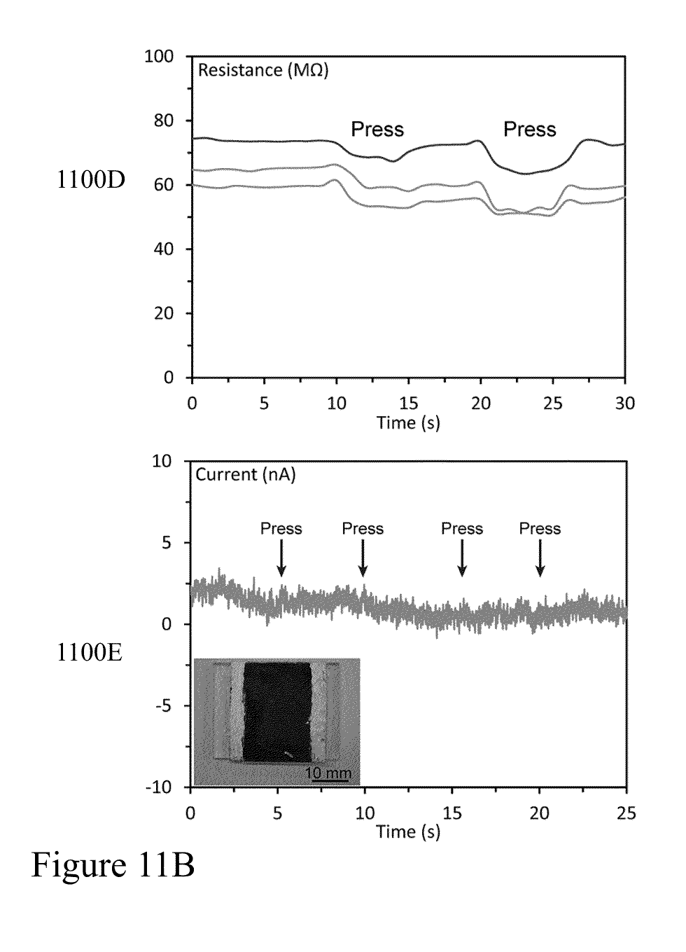

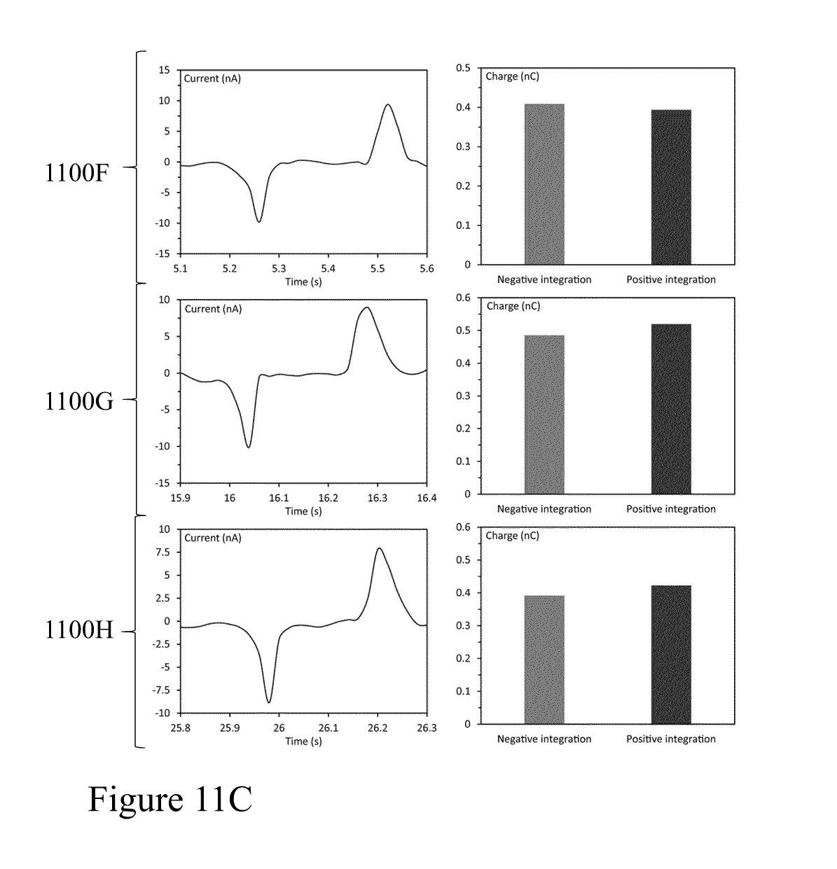

The inventors performed a series of experiments to verify that the current output of the touch button is generated from the piezoelectric response of the ZnO-NW paper. First, the inventors performed control experiments of measuring current outputs of touch buttons made from pure cellulose paper and cellulose paper coated with a layer of ZnO NPs. The ZnO-NP paper was prepared before the hydrothermal growth of ZnO-NWs, and the ZnO NPs, seeded on cellulose fibers of the paper, form a quasi-film as the starting point for ZnO-NW growth. As shown in first graph 1100A in FIG. 11, the touch button made from pure paper only generated current waveforms with very small peak magnitudes (<0.6 nA) upon finger pressing and releasing, and the current waveforms are less regular and more difficult to distinguish from the background noise whose average amplitude is close to 0.2 nA. These small current responses most likely came from the weak piezoelectricity in the cellulose paper. The ZnO-NP paper touch button generated current waveforms with slightly higher peak magnitudes (0.6-1.1 nA) than the pure-paper touch button (second graph 1100B in FIG. 11). However, these peak magnitudes are still just approximately one tenth of the current peak magnitudes (8-10 nA) generated from the ZnO-NW paper buttons in third graph 1100C in FIG. 11. These measurement data, obtained from the two control materials (pure paper and ZnO-NP paper), confirmed that ZnO-NWs are the major source of these repeatable and high-magnitude current waveforms generated from the ZnO-NW paper buttons.

Secondly, the inventors validated that it is the piezoelectricity rather than the piezoresistivity of ZnO-NW paper that causes the current outputs of the touch buttons. When the ZnO-NW paper is pressed, the ZnO-NWs standing radially outwards on the cellulose fiber will be bent down and in contact with each other, which changes the resistivity of the ZnO-NW paper. This piezoresistive effect was illustrated by the measurement data of the resistance of a ZnO-NW paper button upon finger pressing (fourth graph 1100D in FIG. 11B). However, the inventors experimentally proved that, under our setup for current output measurement (precision potentiostat; no offset voltage applied during current measurements), the resistance change of the ZnO-NW paper does not induce any current output. The inventors measured the current output of a ZnO-NW paper button upon presses and delayed releases, during which a finger pressed the touch button, held the press for a few seconds, and then released it. As shown in third graph 1100C in FIG. 11A, the current output has only negative peaks upon pressing and only positive peaks upon releasing. During the period of holding the press, the resistance of the ZnO-NW paper changed to a different level (fourth graph 1100D in FIG. 11D) but there was no obvious change in the current level (third graph 1100C in FIG. 11A). Based on this observation, the inventors believe that the piezoresistive effect of the ZnO-NW paper does not induce obvious current output during touch button operation; thus, the current peaks are generated by the piezoelectric effect of the ZnO-NW paper. During pressing and releasing, the piezoelectric charges were dissipated via current flows through the measurement circuit; thus, the piezoelectric current diminished quickly when the pressing and releasing was completed. As a control experiment, the inventors also used the same experimental setup to measure the press-induced current output of a touch button made from cellulose paper coated with carbon ink (fifth graph 1100E in FIG. 11B). The inventors have shown previously that carbon ink coated on paper has obvious piezoresistive effects upon being deformed and the measurement data, as shown in fifth graph 1100E in FIG. 11B, demonstrates that there was no obvious current peak induced by the presses. This also proved that the piezoresistive effect of the ZnO-NW paper does not lead to current output of the touch button.

As a further proof of the piezoelectric effect in the ZnO-NW paper, the inventors took time integrations of the current waveforms during pressing (negative peaks) and releasing (positive peaks) of the touch button and these integrations quantify the amount of electric charges generated during pressing and releasing. These results are depicted in first to third graph pairs 1100F to 1100H respectively, corresponding to the first, third and fifth peaks of FIG. 9B. If the inventors assume elastic deformations of the ZnO-NW paper, the amounts of charges generated during pressing and releasing should be equal. Our calculation results show that the amounts of generated charges for each pair of negative and positive current peaks are fairly close. This further testifies to the piezoelectric effect in the ZnO-NW paper during touch button operation. The small deviations in the amounts of charges generated during pressing and releasing are possibly due to small unrecovered deformations of the ZnO-NW paper as well as the background noise. The inventors should point out that, although in some current waveforms the negative and positive peaks in a pair have different magnitudes, the time integration results of the current peaks are still very close. The different magnitudes of the positive and negative current peaks are because of the different speeds of finger pressing and releasing. However, it would be evident that the detection of correlated magnitude time-integrated currents is indicative of the haptic interface being pressed. As such, this can provide the basis for a decision circuit on whether a button has been pushed where the haptic interface forms part of a flexible structure such as packaging, an item of apparel, etc.

Based on the above experimental validations, the inventors concluded that the current output of a ZnO-NW paper button mainly results from the piezoelectric response of the ZnO-NWs grown on paper. The ZnO-NWs generate the major portion of the electric charges that form the output currents. Since the randomly oriented ZnO-NWs on cellulose fibers are bent down and contact each other during pressing, it is possible that a portion of the generated electric charges from different ZnO-NWs are neutralized upon contact, since the contact areas from two ZnO-NWs may have opposite piezoelectric charges accumulated upon deformation. On the other hand, the press-induced contacts among different ZnO-NWs could also provide additional pathways for transporting piezoelectric charges and thus enhance the charge transfer efficiency.

In order to fully characterize the piezoelectric properties of the ZnO-NW paper, detailed material characterization may be required. In regard to mechanical properties, the Young's moduli of ZnO-NW and cellulose are expected to be 52 GPa and 130 GPa, respectively. A piece of cellulose paper is a network of interconnected cellulose microfibers with pores, and its effective Young's modulus was measured to be just 2 GPa (assuming homogeneity of cellulose paper). When analyzing the mechanical deformations, one should note the system is a multi-scale complex structure network involving deformations of structures of different sizes, orientations and connections. In regard to electrical properties, piezoelectric coefficient is an important parameter and its measurement requires a sophisticated experimental setup. The inventors did not measure the piezoelectric coefficient of the synthesized ZnO-NWs due to the experimental constraints. According to a previous study on single ZnO-NWs, the effective piezoelectric coefficient (d₃₃) of ZnO-NW grown in the orientation of [0001] can be estimated as 3-12 nm/V. To scrutinize the deformation of individual ZnO-NWs on paper under finger touch, multi-scale mechanical modeling of the hierarchical structure of ZnO-NWs on cellulose microfiber network is required. The reasons are that the nanowires are not well-aligned on randomly woven paper microfibers, and that the deformation of individual ZnO-NWs varied across the entire piece of paper.

B.4 Effect of ZnO-NW Growth Percentage on Device Current Response.

It is a common observation that, given extended growth time, ZnO-NWs grow longer. The inventors measured the weight of paper pieces before and after growth. The inventors defined the growth percentage of ZnO-NWs as weight increase of the paper pieces (vs. weight before growth) in percentage: 100%×(weight after growth−weight before growth)/weight before growth. The inventors investigated the effect of ZnO-NW growth percentage on the device current outputs. In these experiments, the paper pieces were weighed in dry form before and after ZnO-NW growth. Similar to prior art on other substrates, the inventors noted that the ZnO-NWs grew quickly in the first three hours, and the growth slowed down after that and almost stopped after 15 hours. This growth profile can be explained by the gradual depletion of chemicals in the growth solution. The growth percentages after 1.5 hours, 3 hours, and 15 hours are 19.7±0.5%, 30.3±1.2%, and 40.3±0.5%, respectively. Higher growth percentages can be achieved by carrying out the growth for a longer period of time and refreshing the growth solution constantly.

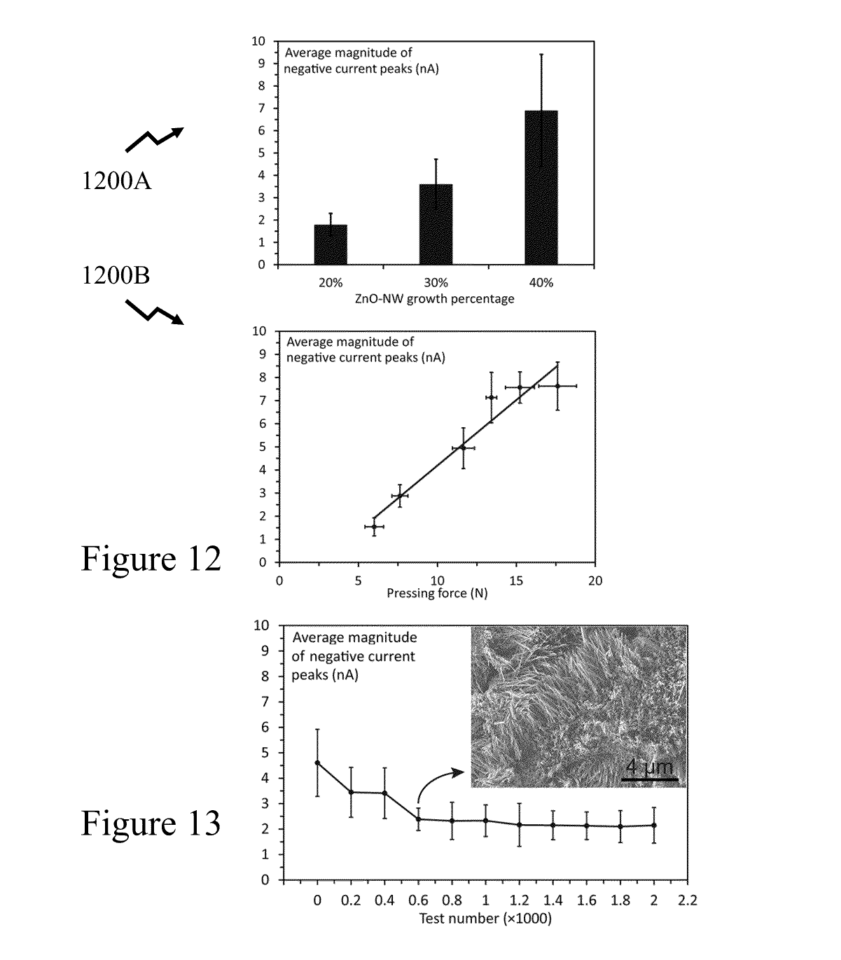

The inventors measured current outputs of the touch buttons, with ZnO-NW growth percentages of 19.7% (1.5-hour growth), 30.3% (3-hour growth), and 40.3% (15-hour growth). As shown in first graph 1200A in FIG. 12, the average magnitude of negative current peaks shows an obvious increasing trend with the growth percentage. The inventors opted not to present the data of average current magnitude vs. ZnO-NW length, because it is hard to clearly identify the root of ZnO-NWs which are grown on non-flat and non-smooth cellulose surface. That is also the major reason the inventors resorted to the parameter, growth percentage, which is more convenient and accurate, to indirectly quantify the length of ZnO-NWs.

Based on the discussions in Section B.3 the inventors speculate two possible reasons for the increased current outputs with higher growth percentages. Firstly, longer ZnO-NWs deflect more under the same pressing force and thus generate more electric charges, and secondly longer ZnO-NWs have higher chance to contact each other when the cellulose fiber they stand on is bent; thus, longer ZnO-NWs may gain more electronic pathways for the charge transport. Although the results imply that a longer period of growth time leads to higher growth percentage and longer ZnO-NWs, along with higher current output, it should be noted that there are limitations to elevating piezoelectric output by increasing growth time or ZnO-NW length. A first arises as other research has shown there is an optimal ratio of ZnO-NW's length to width that generates the highest piezoelectric response. Secondly, over long time growth ZnO-NWs tend to fuse at their tips, which interferes with their growth.

B.5 Effect of Pressing Force on Device Current Response.

The inventors also investigated the current response of touch buttons at different pressing force levels. Hard and gentle presses deform the ZnO-NW paper at different rates and to different extents, thus resulting in different current outputs. The inventors adjusted the pressing force applied to the touch buttons and measured their current outputs. As shown in second graph 1200B in FIG. 12, the average magnitude of negative current peaks increases linearly with the pressing force, with a sensitivity of ˜0.57 nA/N. If a more sensitive response of the touch button is desired, one can choose a thinner and thus more flexible paper substrate and adopt a higher ZnO-NW growth percentage in device preparation. The linear fitting in second graph 1200B in FIG. 12B shows that an initial force (˜2.60N, derived from the linear fitting equation) is needed before a current output can be measured, which represents the cut-off force value of the device's dead zone. One can reduce this cut-off value by using a thinner piece of paper for constructing the touch button, which is more compliant to deformation.

In the experiments, the metal post on the metal stand had a flat circular area (1 mm in diameter) with a similar size to a typical human finger. The inventors experimentally verified that a press by the metal post and a press by a similarly-sized human finger, both with the same level of applied force, generated piezoelectric current outputs from the same button with a discrepancy of <10%. It is reasonable to predict that when the area and shape of the metal post change, the amount of deformed ZnO-NWs and the stress/strain distribution in the ZnO-NW paper will change accordingly. This will definitely lead to the change in the piezoelectric current outputs. To reduce the experimental complexity, the inventors did not investigate the effect of contact shape and area on the touch button output.

B.6 Durability Testing.

Performance degradation after repeated operations could be a concern if the paper-based touch buttons are designed for long-term uses. The inventors tested the device durability through repeated pressing of a touch button made from paper with a ZnO-NW growth percentage of 30%. The button was continuously pressed 2000 times using the metal stand at a high force level of 17.6±1.2 N. After every 200 presses, the current output was measured ten times to calculate the average. As shown in FIG. 13, the average magnitude of negative current peaks decreased gradually during the first 600 presses and started to stabilize after that.

The inventors observed two causes associated with the output degradation. One was that repeated presses resulted in unrecoverable (inelastic) deformation of the paper, which the inventors started to observe after the first 100 presses. This irreversible deformation caused stiffening in the suspended paper structure, decreased the deformation/strain induced by subsequent presses, and thus lowered the current output. Secondly, repeated presses also permanently bent down the ZnO-NWs on paper, making them less stressed in the subsequent presses. This was revealed through SEM imaging of the ZnO-NWs after 600 presses (inset in FIG. 13). The current output stabilized after 600 presses, possibly because the suspended paper reached the limit of inelastic deformation and mainly underwent elastic deformation afterwards. After 2000 presses, the touch button still operated responsively and no mechanical damage was observed on the paper button. In application scenarios where extended uses are targeted, the paper touch buttons can be pre-loaded to reach stabilized performance or, alternatively, in haptic interface designs with voids behind/below the paper layer an elastic layer below the paper may be employed to provide reverse force on the paper or the range of motion limited through the depth of the recess/void behind/below the paper.

B.7 Development and Operation of a Ten-Key Touch Pad.

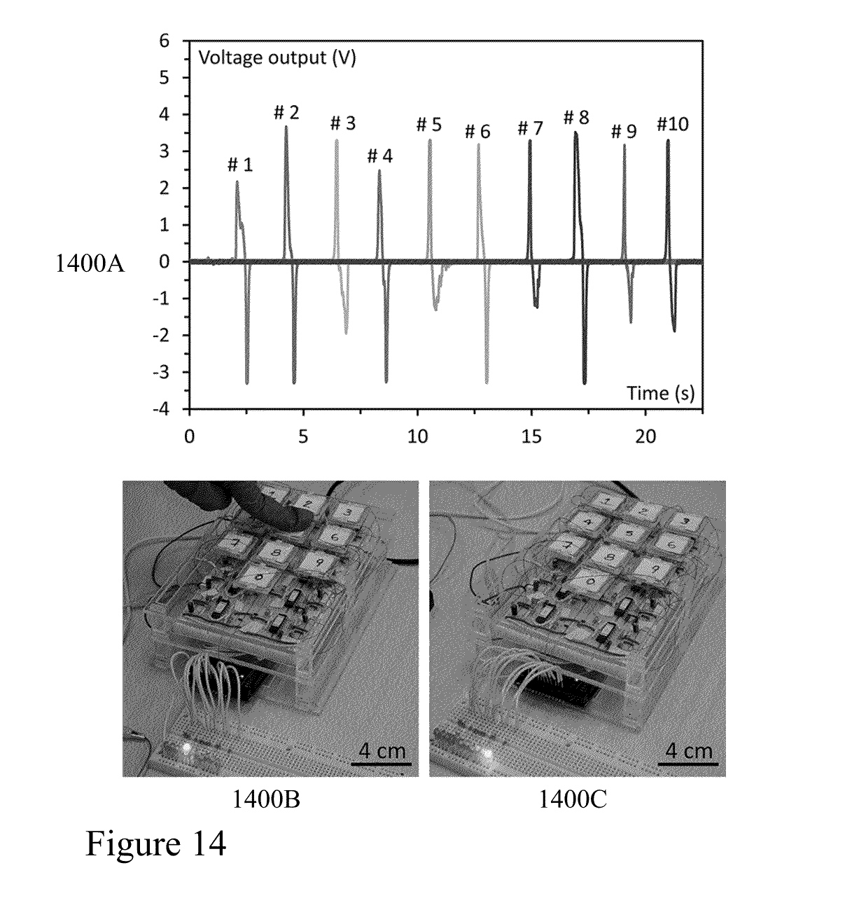

After characterization of the touch button, the inventors constructed a prototype touch pad by forming an array of ten numbered buttons (first and second images 1400B and 1400C in FIG. 14) on an acrylic frame. The touch pad also includes a 10-channel charge amplifier circuits for converting electric charges from the buttons into voltage outputs, a microcontroller circuit for measuring the voltage outputs, and 11 light emitting diodes (LEDs; ten blue and one green) for touch-responsive displays. The green LED lit up if a pre-programmed password was entered correctly. Graph 1400A in FIG. 14 depicts the voltage outputs from the ten touch buttons when they were pressed sequentially by a human operator. The positive peak amplitudes of the voltage outputs vary across different buttons, which could be attributed to the different levels of pressing and environmental noises coupled into the ten channels of the charge amplifier circuit. The microcontroller was programmed to recognize finger pressing by detecting the positive voltage peaks from the touch buttons based on a threshold value. Upon recognition of finger pressing on a specific button, a corresponding blue LED was lit up by the microcontroller (first image 1400A in FIG. 14). To highlight the potential use of our touch pads in paper-based electronics where input of information is needed, we demonstrated the input of a six-digit numeric code on the touch pad. The microcontroller was programmed to compare the inputted code with the preset one and activate the green LED when there was a match (second image 1400B in FIG. 14).

C. Touch Pad Testing

C.1 Prototype Touch Pad Geometry and Test Probe Configuration

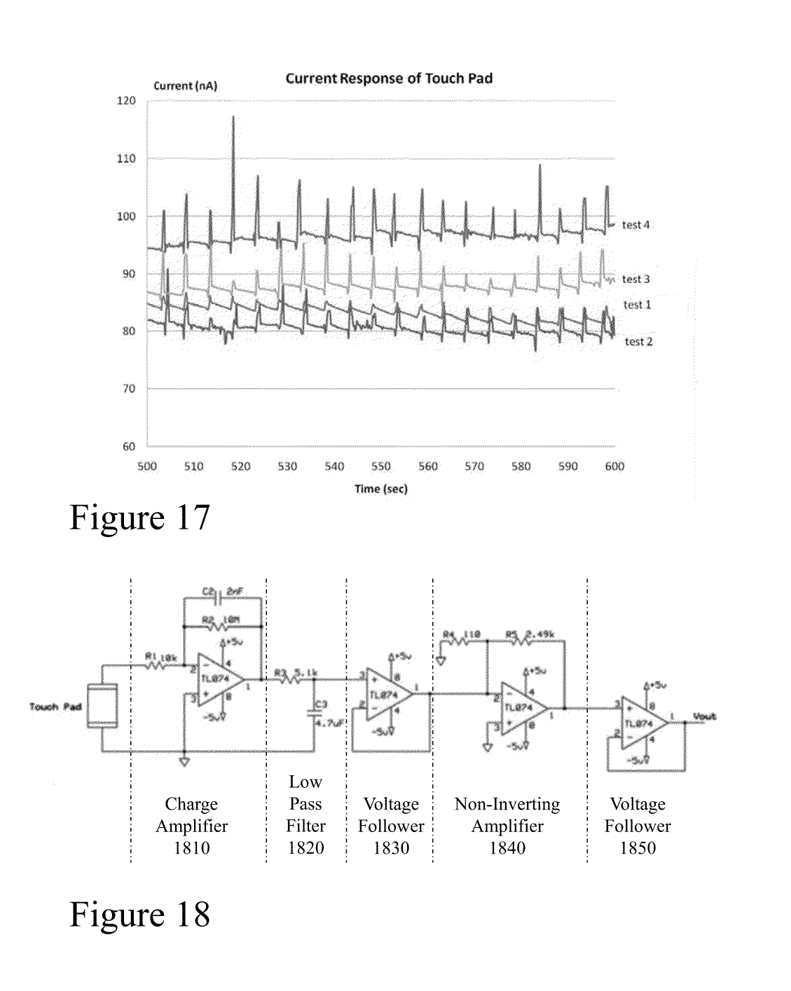

FIG. 15 depicts an exemplary structure of a touch button employed in initial experiments by the inventors, comprising the paper substrate 1530, deposited with ZnO nanowires, attached to a plastic substrate 1540 with a cavity 1550 at the center using double-sided tape (not shown for clarity). The paper was then coated with silver 1520 on one side of the paper at both ends as electrodes, and finally covered with one layer of insulating tape 1530 on the top to prevent direct finger contact with ZnO nanowires or electrodes. FIG. 16 depicts an exemplary test fixture for testing employed by the inventors wherein the inventive haptic paper assembly 1610 is placed upon a support 1620 above and around which is a test frame 1630 that supports the test probe 1640 which is a 10 mm diameter flat-ended post. By adjusting spacers (not depicted for clarity), the test probe 1640 could be brought into contact with the haptic paper assembly 1610 and a known force applied through a balance beneath the support 1620. The test configuration depicted in FIG. 16 providing a constant and stable mechanical deformation to the haptic paper assembly 1610. A source meter was used to measure the generated current from the two electrodes wherein every time the touch pad was pressed via the test assembly an increase in current can be measured, as shown in FIG. 17 for an applied deformation of 3 mm.

C.2 Prototype Readout Circuit

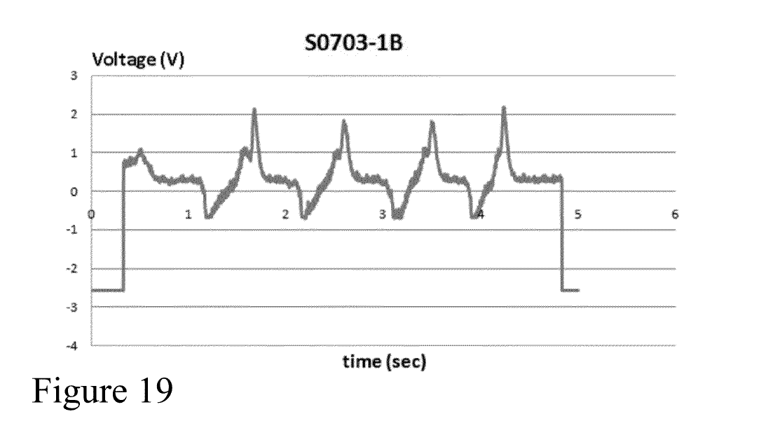

To establish initial haptic paper assemblies as discrete buttons or touch pads into a portable and practical prototype without requiring the source meter for current measurement, an electrical circuit was developed for converting the generated charge into a voltage output as depicted in FIG. 18. The circuit comprises a charge amplifier circuit 1810, a low-pass filter 1820, a voltage follower 1830, a non-inverting amplifier 1840 and a second voltage follower 1950. The circuit generates a voltage pulse when the touch pad is pressed, as evident from FIG. 19 where the output from the circuit is depicted for a series of four presses.

The interface circuit employs the charge amplifier 1810 with converted piezoelectric charges being generated from a finger press into a voltage signal, and the low-pass filter 1820 and voltage follower 1830 subsequently remove high-frequency noise from the system. The non-inverting amplifier 1840 following it then amplifies the output voltage to a measurable level (e.g. 1.5-2.5 V).

D. Other Sensors

It would be evident that the ZnO-nanowire-coated paper allows for a range of haptic interfaces to be implemented according to the pattern of the ZnO-NWs and the electrical contacts. Accordingly, as discussed supra, buttons and keypads exploiting such buttons can be formed with or without cavities behind the regions defining each button. Such structures allow for structures to be formed providing finger “swipe” detection in one dimension (1D) or two dimensions (2D) for example.

Alternatively, two sheets with a patterned insulating layer between would allow for electrical contact detection to be performed where the user's finger pressure (for example) deforms the upper sheet (assuming a more rigid lower sheet or sheet attached to a substrate). Based upon the patterning of the intermediate dielectric and lower sheet a variety of patterns can be implemented for discrete “button” push detection, finger “swipe” detection in one dimension (1D) or two dimensions (2D). Similarly, patterning of the upper and lower sheets may provide for enhanced 2D functionality as per a touch pad, for example. Optionally, rather than detecting electrical current in the paper or electrical contact closure, haptic interfaces exploiting nanowire-enabled paper may exploit capacitance effects to define user haptic motion.

Paper based haptic interfaces exploiting piezoelectric effects as evident from the results presented supra provide for pressure detection and/or measurement in combination with button pushing. As such, paper-based haptic interfaces may provide improved security as the pressure and/or timing pattern of an authorised user exploiting a memorized passcode will generally be different to that of an unauthorised user.

The inventors also envisage exploiting the same sensing principle(s) for other types of sensors. For instance, if a proof mass is attached to the center of the touch pad, the device becomes a piezoelectric accelerometer.

The ZnO-nanowire-coated paper substrate could be further patterned through mechanical cutting, to form flexures and a central piece of paper substrate. The flexures tether the central piece of paper substrate with the proof mass, and could potentially improve the accuracy of the acceleration measurement. Another type of sensor this technology could enable is force sensors. A cantilever of ZnO-nanowire-coated paper could be used to detect forces applied to the free end of the cantilever. Once the beam is bent, the ZnO nanowires on paper will be deformed and thus generate piezoelectric charges. These sensors could further enrich the range of applications of this technology in “smart” packaging, biomedical and industrial sensing, and consumer electronics.

Accordingly, it is evident that paper-based piezoelectric ZnO touch pads and provide new solutions to two technologies: touch sensing and flexible electronics. In the field of touch sensing technology, one of the most well-known and popular sensing mechanisms is capacitive touch sensing. In contrast to existing commercial capacitive touch pads, piezoelectric ZnO touch pads represent an innovative solution that is lower cost. Moreover, in the field of electronics, the technology now experiences a shift from conventional electronics on metallic prototype boards to lighter, cheaper, disposable and more environmental friendly materials such as paper. The development of such touch pads provides a new device-user interface that is completely compatible with flexible electronics, particularly with paper-based electronics.

This type of touch pads can be used as a reliable device-user interfaces as well as motion/touch sensors (force/touch sensors and event accelerometers) in products and applications including, but not limited to, smart packaging, with information storage, security, shipping condition monitoring etc.; consumer electronics; wearable devices; smart clothing; electronic greeting cards—business cards—stationary etc.; electronic interlocks, and interactive games etc. For instance, it could be also used in consumer electronics as an electronic keypad lock for anything from doors, home appliances, storage cabinets and much more. In addition, paper-based touch pad technology can also be applied to innovative electronic accessories such as interactive children books, greeting cards, children toys, product packaging, etc. In addition to providing innovative low cost options in existing applications paper-based haptic interfaces may provide additional benefits and options with credit card circuits, disposable biodegradable smart tags, flexible displays, and single-use diagnostic biosensors.

The single-layer touch pad design according to embodiments of the invention can be integrated into many interactive electronic paper products such as business and greeting cards, boarding passes, intelligent magazines. Creative cutting and folding of paper patterned with ZnO-NWs can make “smart” paper toys that respond to physical interactions from users (e.g., pressing, bending, and accelerating). The piezoelectric mechanism for physical sensing could also enable the development of low-cost disposable force sensors and accelerometers.

The innovative design of paper-based piezoelectric touch pads outlined within this specification allows them to serve as interfaces for user input of information. The innovative touch pad designs according to embodiments of the invention have five beneficial characteristics for uses in paper-based electronics:
1. The piezoelectric sensing principle is, in principle, applicable to most types of paper substrates as the hydrothermal synthesis of ZnO-NWs can be performed on virtually any paper substrates with proper mechanical stability, making the design useful for many paper-based electronic devices involving different paper substrates;
2. The design just needs a single layer of paper, which simplifies the device assembly, design, etc.;
3. The device is simple-to-fabricate and low-cost without requiring sophisticated microfabrication facilities;
4. The device fabrication process is compatible with existing techniques for constructing electronic circuits on paper substrates (e.g., inkjet and screening printing). The hydrothermal growth of ZnO-NWs is performed in a moderate chemical solution at relatively low temperatures (50-100° C.), which does not substantially change the chemical and mechanical properties of the paper substrate and hence permits subsequent fabrication of electronic components on the same paper substrate; and
5. The hydrothermal synthesis of ZnO-NWs is highly selective and spatially guided by the seeding layer of ZnO NPs. One can easily pattern the seeding layer via inkjet printing of the ZnO-NP solution, and conduct selective growth of ZnO-NWs on paper with micrometer resolution (determined by the resolution of inkjet printing). This will potentially lead to more versatile designs of paper-based touch sensors.

It would be evident that in addition to using paper as an electronic substrate it is also possible to hydrothermally grow ZnO-NWs on plastic substrates, which represent another type of common materials for constructing flexible electronic devices. Compared to plastic, paper has the following advantages for use as an electronic substrate.
1. Paper is rapidly biodegraded and biodegradable in all forms, readily disposable by incineration as well as composting etc. and thus more environmentally-friendly than plastic even where the plastic is biodegradable;
2. There exist mature mass-production techniques for manufacturing paper materials (e.g., printing, folding, and cutting), which could be adapted to manufacturing paper-based electronic products; and
3. As a substrate for growing ZnO-NWs, the porous structure of cellulose paper provides a higher surface-to-volume ratio than plastic substrates, which allows the growth of more ZnO-NWs per unit area of substrate.

Whilst within the prior art the use of ZnO-NW paper for energy harvesting has been reported, the inventors are unaware of any prior demonstration of paper-based piezoelectric touch sensor. Further, the procedures of growing ZnO-NWs on paper is different from that in the prior art. For example, the prior art exploits sputtered ZnO NPs on paper, while the inventors prepared a ZnO-NP colloidal solution and dipped paper into it for seeding, which does not require sophisticated equipment. For hydrothermal synthesis of ZnO-NWs, the inventors utilized ammonium hydroxide as an assistant chemical to suppress the homogenous nucleation of ZnO in solution, which leads to thinner ZnO-NWs (69.61 nm after 15-hours growth) than that (100-200 nm after 3-hour growth) in the prior art.

With respect to the detailed physical mechanisms, the inventors dedicated a series of experiments to understanding the mechanism of the current responses from the developed touch pads. The inventors obtained that the ZnO-NWs grown on paper made the major contribution to the output current peaks and that the force-induced piezoresistive effect of ZnO-NW paper did not lead to obvious current response of the touch pad and that the piezoelectric charges generated during force application and removal are approximately equal.

The inventors have developed prototype touch pads for proof-of-concept demonstrations, and further engineering improvements can be performed to enhance the device performance or extend the functionality. The consistency of output voltages from different touch buttons can be further improved through better control of the ZnO growth consistency and environmental noises coupled into the charge amplifier circuit. Selective growth of ZnO-NW and corresponding patterning of conductive inks (as electrodes) can be achieved, via techniques such as inkjet printing, to form addressable arrays of touch sensing “pixels” with potentially smaller footprint. This will further increase the level of device integration. The major limitations of reducing the sensing “pixel” size include the patterning resolution of the hydrothermally grown ZnO-NWs (mainly determined by inkjet printing resolution of the seeding solution) and the size-related limitation of the piezoelectric current output of each patterned sensing “pixel” (the smaller the pixel, the lower the output current). The whole charge amplifier circuit can be integrated onto the same paper substrate using existing circuit fabrication techniques in paper-based electronics.

Whilst embodiments of the invention have been described with respect to ZnO nanowires, it would be evident that other materials may be employed that can form similar nanowire patterns. Within other embodiments of the invention the paper—nanowire combination may be combined through the exploitation of piezoelectric fibers such as wood and silk, for example, such that an underying paper substrate may be covered with piezoelectric fibers of appropriate dimensions, density, etc. Other piezoelectric materials may include, but are not limited, to some viral proteins (e.g. M13 bacteriophage), perovskite ceramics, phosphor-bronze structure ceramics, zincblende and wurtzite semiconductor structures in III-V and II-VI semiconductors, polymers (e.g. polyvinylidene fluoride), and organic nanostructures (e.g. self-assembled diphenylalanine peptide nanotubes (PNTs)).

Whilst the embodiments of the invention have been described with respect to silver electrodes it would be evident that within other embodiments of the invention electrical patterns, traces, tracks, electrodes etc. may be formed from one or more other electrically conductive materials including but not limited to metals, alloys, conductive polymers, and organic conductors.

Within embodiments of the invention the paper based haptic interface may be disposed upon a carrier or substrate having one or more recesses defined within that allow for the deformation of the ZnO-NW loaded paper. This carrier or substrate may be rigid, flexible, formed from paper, cardboard, a paper based material, plastic, fabric etc. as well as other materials such as wood, glass, ceramic, etc. Such recesses may be formed by stamping, cutting, machining, casting, engraving, and laminating. However, within other embodiments of the invention the substrate may comprise regions having a different material property and/or composition. For example, the substrate may be a polymer wherein the polymer exhibits a first Young's modulus when fully cured and a second Young's modulus when not fully cured such that the regions beneath the paper for which deformation is “allowed” or desirable are not fully cured and may exhibit elasticity whereas the remainder is fully-cured rigid polymer.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A haptic interface comprising:
a substrate;
a first layer comprising a paper having a first predetermined region coated with nanowires formed from a material exhibiting piezoelectricity;
a second layer formed from an electrically conductive material patterned with respect to the first predetermined region of the first layer; and
a third layer comprising an insulator disposed atop the first and second layers; wherein
application of pressure to the third layer results in deformation of at least one of the nanowires and a second predetermined region of the first layer thereby generating a first electrical current.

2. The haptic interface according to claim 1, wherein
the second predetermined region of the first layer is at least one of the first predetermined region experiencing pressure and a region of the first layer defined with respect to a cavity within the substrate such that the second predetermined region of the first layer deforms under the application of pressure.

3. The haptic interface according to claim 1, wherein
removal of the applied pressure to the third layer results in generation of a second electrical current due to the recovery of at least one of the nanowires and a second predetermined region of the first layer.

4. The haptic interface according to claim 1, wherein
the substrate comprises a recess of a plurality of recesses wherein the recess defines the second predetermined region of the first layer.

5. The haptic interface according to claim 1, wherein
the nanowires are zinc oxide and are grown using at least one of a hydrothermal process and a zinc oxide nanoparticle seed layer.

6. A haptic interface comprising:
a substrate;
a first layer comprising a paper having a first predetermined region coated with nanowires formed from a material exhibiting piezoelectricity;
a second layer formed from an electrically conductive material patterned with respect to the first predetermined region of the first layer; wherein
application of pressure to the first predetermined region of the first layer results in deformation of at least one of the nanowires and a second predetermined region of the first layer thereby generating a first electrical current.

7. The haptic interface according to claim 6, wherein
the second predetermined region of the first layer is at least one of the first predetermined region experiencing pressure and a region of the first layer defined with respect to a cavity within the substrate such that the second predetermined region of the first layer deforms under the application of pressure.

8. The haptic interface according to claim 6, wherein
removal of the applied pressure to the third layer results in generation of a second electrical current due to the recovery of at least one of the nanowires and a second predetermined region of the first layer.

9. The haptic interface according to claim 6, wherein
at least one:
the substrate comprises a recess of a plurality of recesses wherein the recess defines the second predetermined region of the first layer;
the substrate is biodegradable; and
the substrate is a flexible material forming a predetermined portion of at least one of an item of apparel, a package, a container and a sheet for wrapping around an object.

10. The haptic interface according to claim 6, wherein
the nanowires are zinc oxide and are grown using at least one of a hydrothermal process and a zinc oxide nanoparticle seed layer.

11. The haptic interface according to claim 6, further comprising
a controller, the controller for receiving the electrical currents generated and determining upon detecting a correlation between a time integrated positive current and a time integrated negative current that an action has been performed that applied and removed pressure with respect to the to the first predetermined region of the first layer has occurred.

12. The method according to claim 11, wherein
the substrate and plurality of layers are flexible at least in the region surrounding the first predetermined region of the first layer; and
the determination by the controller reduces false action determinations of actions by ignoring electrical currents generated from flexure of the flexible region of the item.

13. The method according to claim 12, wherein
the substrate and plurality of layers form part of either packaging or an item of apparel.

14. A haptic interface comprising:
a first layer comprising a paper having a first predetermined region coated with nanowires formed from a material exhibiting piezoelectricity;
a second layer formed from an electrically conductive material patterned with respect to the first predetermined region of the first layer; wherein
application of pressure to the first predetermined region of the first layer results in deformation of at least one of the nanowires and a second predetermined region of the first layer thereby generating a first electrical current.

15. The haptic interface according to claim 14, wherein
the second predetermined region of the first layer is at least one of the first predetermined region experiencing pressure and a region of the first layer defined by a difference in at least one of a property and a composition of a first portion of a substrate beneath at least the first predetermined portion of the first layer and a second portion of the substrate surrounding a predetermined portion of the first portion.

16. The haptic interface according to claim 14, wherein
removal of the applied pressure results in generation of a second electrical current due to the recovery of at least one of the nanowires and a second predetermined region of the first layer.

17. The haptic interface according to claim 15, wherein
at least one:
first portion of the substrate is a recess;
the first portion of the substrate is flexible;
the substrate is biodegradable; and
the substrate is a flexible material forming a predetermined portion of at least one of an item of apparel, a package, a container and a sheet for wrapping around an object.

18. The haptic interface according to claim 14, wherein
the nanowires are zinc oxide and are grown using at least one of a hydrothermal process and a zinc oxide nanoparticle seed layer.

19. The haptic interface according to claim 14, further comprising
a controller, the controller for receiving the electrical currents generated and determining upon detecting a correlation between a time integrated positive current and a time integrated negative current that an action has been performed that applied and removed pressure with respect to the to the first predetermined region of the first layer has occurred.

20. The method according to claim 19, wherein
the substrate and plurality of layers are flexible at least in the region surrounding the first predetermined region of the first layer; and
the determination by the controller reduces false action determinations of actions by ignoring electrical currents generated from flexure of the flexible region of the item.

21. The method according to claim 20, wherein
the substrate and plurality of layers form part of either packaging or an item of apparel.
